(19) United States
(12) Patent Application Publication
(10) Pub. No.: US 2013/0077100 A1
(43) Pub. Date: Mar. 28, 2013

(54) SURFACE SHAPE MEASUREMENT METHOD AND SURFACE SHAPE MEASUREMENT APPARATUS

(71) Applicants: Atsushi Fukui, Osaka (JP); Hirotoshi Oikaze, Hyogo (JP)

(72) Inventors: Atsushi Fukui, Osaka (JP); Hirotoshi Oikaze, Hyogo (JP)

(21) Appl. No.: 13/700,261

(22) PCT Filed: Dec. 15, 2011
(86) PCT No.: PCT/JP2011/007012

§ 371 Date: Nov. 27, 2012

(30) Foreign Application Priority Data
Dec. 17, 2010 (JP) 2010-281587

(51) Int. Cl. G01B 11/24

(52) U.S. Cl. CPC G01B 11/2441
USPC 356/511

(57) ABSTRACT

The present surface shape measurement method includes: splitting white light that includes different wavelengths into reference light and measurement light; causing the measurement light to enter a measurement target plane; causing the reference light to enter a first diffraction grating; combining the reference light having passed through a first optical path from the first diffraction grating to enter a second diffraction grating and thereafter having passed through the first optical path from the second diffraction grating to enter the first diffraction grating to be output from the first diffraction grating and the measurement light reflected from the measurement target plane, to form interfering light, to thereby measure a surface shape of the measurement target plane.

### TECHNICAL FIELD

The present invention relates to a surface shape measurement method and a surface shape measurement apparatus using white light interferometry.

### BACKGROUND ART

Surface shape measurement apparatuses that measure the convex and concave shapes of a precision processed product such as a semiconductor wafer, a liquid crystal display-use glass substrate, or the like using interference of white light is known. With reference to FIG. 15, a description will be given of a conventional surface shape measurement apparatus (see Patent Document 1).

The conventional surface shape measurement apparatus 100 guides white light from a white light source 101 via a first lens 102 to a half mirror 103, such that the white light reflected from the half mirror 103 is condensed by the second lens 104. Further, the conventional surface shape measurement apparatus 100 is structured to emit the condensed white light to a measurement target plane 106 via a beam splitter 105. The beam splitter 105 is a splitting means for splitting the white light into white light to be emitted to the measurement target plane 106 (hereinafter referred to as the measurement light), and white light to be emitted to a reference plane 107 (hereinafter referred to as the reference light). The reference light is reflected from a reflecting unit 107a of the reference plane 107, and thereafter re-enters the beam splitter 105. On the other hand, the measurement light is reflected from the measurement target plane 106, and thereafter re-enters the beam splitter 105. The beam splitter 105 also has a function as a combining means for combining the reference light reflected from the reflecting unit 107a and the measurement light reflected from the measurement target plane 106 into the light that progresses the identical path again. At this time, what occurs is the interference phenomenon that corresponds to the difference between a distance L1 from the measurement target plane 106 to the beam splitter 105 and a distance L2 from the beam splitter 105 to the reference plane 107 (an optical path length difference between the measurement light and the reference light). The white light with which the interference phenomenon occurs (hereinafter referred to as the interfering light) is imaged by a CCD camera 109 via an image forming lens 108. The CCD camera 109 images the measurement target plane 106 together with the interfering light.

Here, by shifting the beam splitter 105 upward and downward by a not-shown shifting means so as to change the positional relationship between the distance L1 and the distance L2, the optical path length difference between the measurement light and the reference light is changed. Thus, beams of the interfering light entering the CCD camera 109 enhance or weaken one another. For example, with reference to a particular place in the measurement target plane 106 in the region imaged by the CCD camera 109, the position of the beam splitter 105 is changed. Accordingly, by measuring the signal having the intensity of the interfering light at the particular place (hereinafter referred to as the interference intensity signal), the graphs shown in (a) to (c) of FIG. 16 can be obtained. In (a) to (c) of FIG. 16, the vertical axis indicates the intensity of the interference intensity signal detected by the CCD camera 109, and the horizontal axis indicates the distance L1 from the measurement target plane 106 to the beam splitter 105 (the height of the measurement target plane 106).

Theoretically, the graph showing the relationship between the intensity of the interference intensity signal and the height of the measurement target plane 106 can be obtained as the waveform signal of the interference intensity signal such as shown in (a) of FIG. 16. Based on the waveform signal, the height of the measurement target plane 106 can be obtained. However, since the interfering light is actually imaged by the CCD camera 109 every time shift is made by a preset interval dimension (i.e., a sampling interval dimension), the obtained data pieces are discrete as shown in (b) of FIG. 16. Therefore, it is necessary to obtain the waveform signal of the interference intensity signal from the acquired discrete data. Accordingly, by obtaining the characteristic function from the discrete data shown in (b) of FIG. 16, the waveform signal of the interference intensity signal is approximated as shown in (c) of FIG. 16. The conventional surface shape measurement apparatus 100 obtains the height of the measurement target plane 106 based on the approximated waveform signal of the interference intensity signal.

### CITATION LIST

### Patent Literature

PLT 1: Japanese Unexamined Patent Publication No. 2001-66122

### SUMMARY OF INVENTION

### Technical Problem

However, with the conventional surface shape measurement apparatus 100, the interference intensity signal can only be detected within a limited optical path length difference range, in which the optical path length difference between the measurement light and the reference light is extremely small. Therefore, the height shape of the measurement target plane 106 must be measured with extremely fine change steps in the optical path length difference. Accordingly, the number of times of performing measurement becomes increasing, and much time is required for measuring the height of the measurement target plane 106. In particular, as the height difference of the measurement target plane 106 is greater, the time required for the measurement becomes significantly longer.

The present invention is to solve such issues, and an object of the invention is to provide a surface shape measurement method and a surface shape measurement apparatus which make it possible to widen the range of the optical path length difference in which the interference intensity signal can be detected and to measure the measurement target plane at high speeds.

### Solution to Problem

In order to achieve the aforementioned object, the present invention is structured as follows.

According to one aspect of the present invention, there is provided a surface shape measurement method, comprising:
splitting white light that includes different wavelengths into reference light and measurement light;
causing the reference light to enter a first diffraction grating, to thereafter pass through a first optical path to enter a second diffraction grating, and further thereafter causing the reference light to pass through the first optical path from the second diffraction grating to enter the first diffraction grating, while causing the measurement light to enter a measurement target plane to be reflected from the measurement target plane, and combining the reference light and the measurement light to form interfering light;
detecting an interference intensity of the interfering light; and
measuring a surface shape of the measurement target plane based on the interference intensity.

According to another aspect of the present invention, there is provided a surface shape measurement apparatus, comprising:
a light source that emits white light including different wavelengths;
a splitting unit that splits the white light into reference light and measurement light;
a table on which a measurement target object to which the measurement light is emitted is placed;
a first diffraction grating having a grating in a first direction formed at a first pitch, the reference light perpendicularly entering the first diffraction grating;
a second diffraction grating having a grating in the first direction formed at a pitch half as great as the first pitch, the second diffraction grating being arranged in parallel to the first diffraction grating, and the reference light having exited from the first diffraction grating entering the second diffraction grating;
a combining unit that combines the reference light having exited from the second diffraction grating and thereafter having exited from the first diffraction grating and the measurement light reflected from the measurement target object, to form interfering light;
a detecting unit that detects an interference intensity of the interfering light; and
a measuring unit that measures a surface shape of the measurement target object based on the interference intensity.

According to still another aspect of the present invention, there is provided a surface shape measurement apparatus, comprising:
a light source that emits white light including different wavelengths;
a splitting unit that splits the white light into reference light and measurement light;
a table on which a measurement target object to which the measurement light is emitted is placed;
a first diffraction grating having a grating in a first direction formed at a first pitch, the reference light perpendicularly entering the first diffraction grating;
a second diffraction grating having a grating in the first direction formed at the first pitch, the second diffraction grating being arranged in parallel to the first diffraction grating, and the reference light having exited from the first diffraction grating entering the second diffraction grating;
a mirror that reflects the reference light having exited from the second diffraction grating such that the reference light enters the second diffraction grating;
a combining unit that combines the reference light having been reflected from the mirror and thereafter having exited from the second diffraction grating and the first diffraction grating in order and the measurement light reflected from the measurement target object, to form interfering light;
a detecting unit that detects an interference intensity of the interfering light; and
a measuring unit that measures a surface shape of the measurement target object based on the interference intensity.

### EFFECTS OF INVENTION

As described above, with the surface shape measurement method and the surface shape measurement apparatus of the present invention, it becomes possible to widen the range of the optical path length difference in which the interference intensity signal can be detected and to measure the measurement target plane at high speeds.

### BRIEF DESCRIPTION OF DRAWINGS

The feature of the present invention will become clear from the following description taken in conjunction with embodiments thereof with reference to the accompanying drawings, in which:

FIG. 1A is a schematic view of a surface shape measurement apparatus according to a first embodiment;

FIG. 1B is a block diagram of a CPU of the surface shape measurement apparatus according to the first embodiment;

FIG. 1C is a schematic view of a reference unit according to the first embodiment;

FIG. 1D is a schematic view showing a reference unit according to a variation of the first embodiment;

FIG. 1E is a block diagram of a CPU of a surface shape measurement apparatus according to a second embodiment;

FIG. 2 is an explanatory view describing the manner of reference light that is diffracted by a first diffraction grating and a second diffraction grating according to the first embodiment;

FIG. 3A is a graph showing the relationship between the interference intensity signal and the optical path length difference in the case where the optical path length difference is −40 to 40 μm in a conventional surface shape measurement method;

FIG. 3D is a graph showing the relationship between the interference intensity signal and the optical path length difference in the case where the optical path length difference is −5 to 5 μm in the conventional surface shape measurement method;

FIG. 4 is an explanatory view describing the interference intensity signal and the manner in which the interference intensity signal is subjected to wavelength resolution in the conventional surface shape measurement method;

FIG. 5 is a graph showing the relationship between the phase and the wavelength of an interference intensity signal in the conventional surface shape measurement method;

FIG. 6A is a graph showing the relationship between the interference intensity signal and the optical path length difference in the case where the optical path length difference is −40 to 40 μm in the surface shape measurement apparatus according to the first embodiment;

FIG. 6B shows a graph showing the relationship between the interference intensity signal and the optical path length difference in the case where the optical path length difference is −5 to 5 μm in the surface shape measurement apparatus according to the first embodiment;

FIG. 7 is an explanatory view describing the interference intensity signal and the manner in which the interference intensity signal is subjected to wavelength resolution in the surface shape measurement apparatus according to the first embodiment;

FIG. 8 is a graph showing the relationship between the phase and the wavelength of the interference intensity signal in the surface shape measurement apparatus according to the first embodiment;

FIG. 9 is a flowchart showing the operation of the surface shape measurement apparatus according to the first embodiment;

FIG. 10 is a schematic view showing the structure of a reference unit according to a third embodiment;

FIG. 11A is a schematic view showing the structure of a reference unit according to a fourth embodiment;

FIG. 11B is a schematic view showing the structure of a reference unit according to a variation of the fourth embodiment;

FIG. 11C is a schematic view showing the structure of a reference unit according to a further variation of the fourth embodiment;

FIG. 12 is a schematic view showing the structure of a reference unit according to a fifth embodiment;

FIG. 13 is a schematic view showing the structure of a reference unit according to a first variation of the fifth embodiment;

FIG. 14 is a schematic view showing the structure of a reference unit according to a second variation of the fifth embodiment;

FIG. 15 is a schematic view showing the structure of a conventional surface shape measurement apparatus;

FIG. 16 is a view showing the manner until the waveform of the interference intensity signal is obtained by the conventional surface shape measurement apparatus, in which (a) shows the waveform of the theoretical interference intensity signal; (b) shows a plot of an actually measured interference intensity signal; and (c) shows the waveform of an interference intensity signal approximated by the characteristic function;

FIG. 17A is a view describing one example of the cross-sectional shape of the diffraction grating applicable to the first to fifth embodiments;

FIG. 17B is a view describing another example of the cross-sectional shape of the diffraction grating applicable to the first to fifth embodiments; and

FIG. 17C is a view describing still another example of the cross-sectional shape of the diffraction grating applicable to the first to fifth embodiments.

### DESCRIPTION OF EMBODIMENTS

Before the description of the present invention proceeds, it is to be noted that same parts are designated by same reference numerals throughout the accompanying drawings.

In the following, with reference to the drawings, a description will be given of the embodiments of the present invention.

### First Embodiment

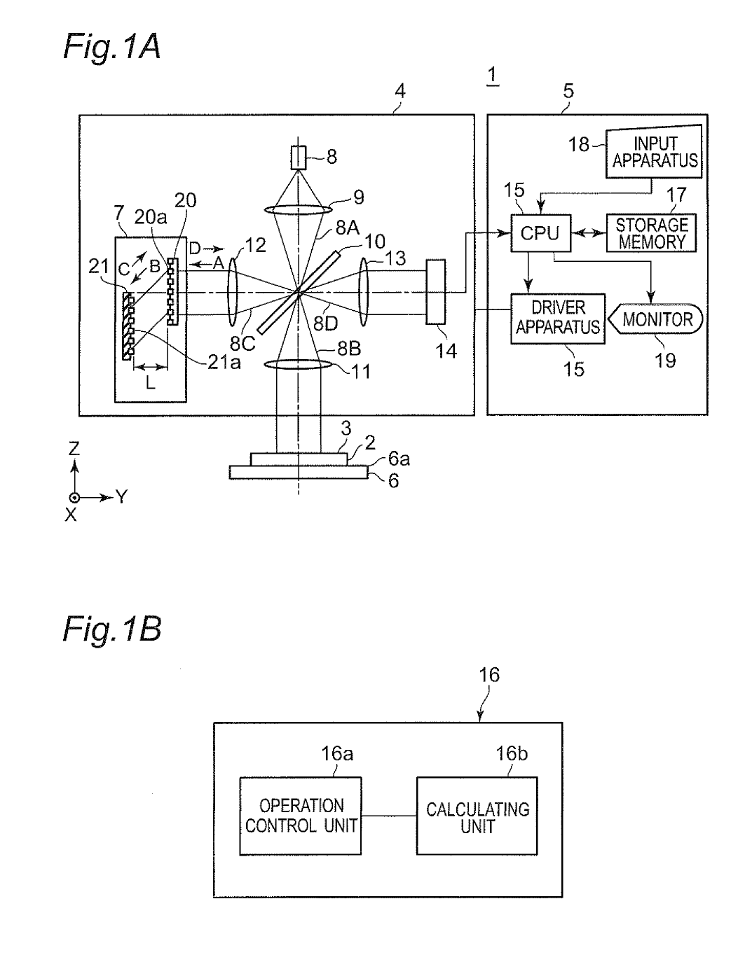

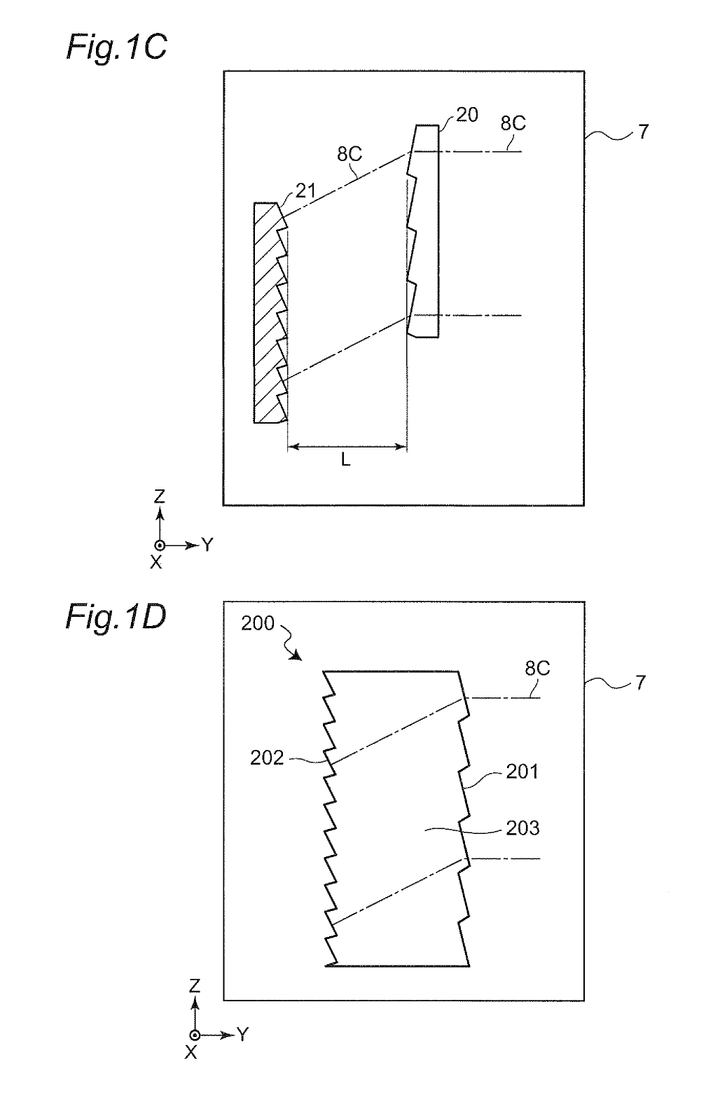

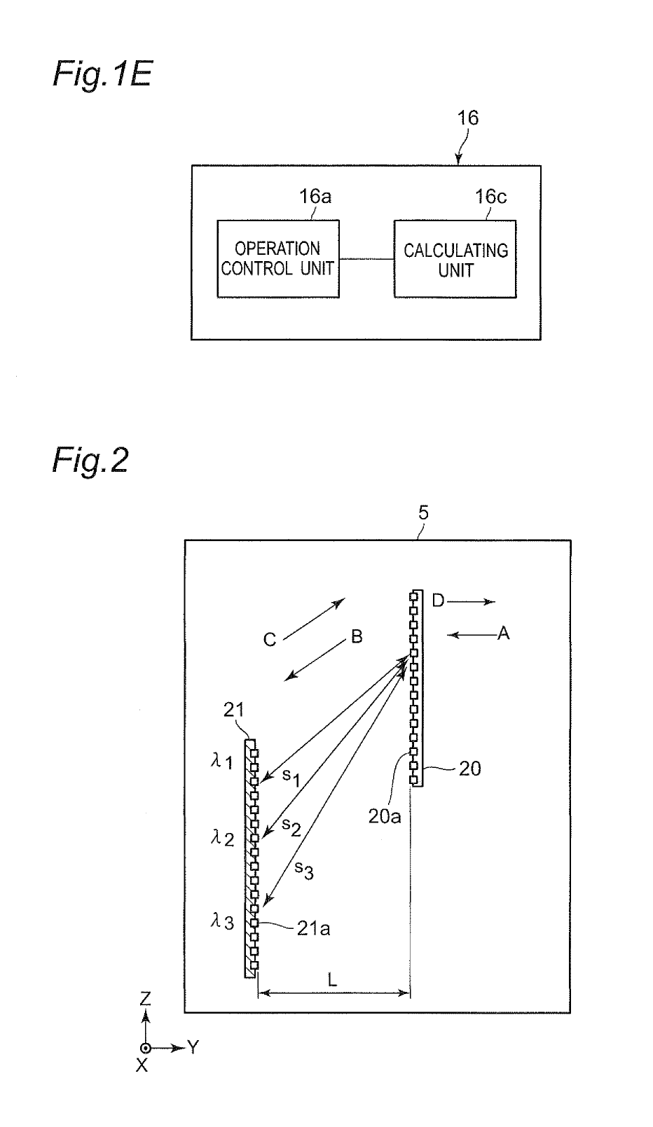

FIG. 1A is a schematic view showing a surface shape measurement apparatus 1 according to a first embodiment. First, an overview of the surface shape measurement apparatus 1 will be described. The surface shape measurement apparatus 1 includes: an optical system unit 4 that emits white light of a particular frequency band to a measurement target plane 3 being the surface of a measurement target object 2, to receive reflected light; a control drive system unit 5 that controls and drives the optical system unit 4; and a table 6 for placing the measurement target object 2 thereon. The measurement target object 2 is, for example, an aspheric lens, a circuit board, or the like. The optical system unit 4 includes a reference unit 7. The white light is emitted also to the reference unit 7. This reference unit 7 will be detailed later and, therefore, the description thereof is not given herein.

The surface shape measurement apparatus 1 causes the white light reflected from the measurement target plane 3 and the white light reflected inside the reference unit 7 to interfere with each other, to measure the height information (the position in Z axis direction shown in FIG. 1A) within the plane of the measurement target plane 3 (i.e., the X-Y plane defined by the X axis and the Y axis shown in FIG. 1A). In other words, the surface shape measurement apparatus 1 measures the surface shape of the measurement target plane 3. In this case, the surface shape measurement apparatus 1 measures the height information from a preset reference plane 6a. As the reference plane 6a, it is preferable to use the surface of the table 6 on which the measurement target object 2 is placed. Use of the surface of the table 6 as the reference plane 6a enables measurement of the surface shape even when the measurement target object 2 is unknown. It is to be noted that, in the case where the average height of the measurement target object 2 is known, the position of the average height can be set as the reference plane 6a. Further, the table 6 is fixed to the installation floor where the surface shape measurement apparatus 1 is installed.

In the following, the structure of the surface shape measurement apparatus I will be detailed with reference to FIG. 1A.

First, a description will be given of the optical system unit 4 included in the surface shape measurement apparatus 1. The optical system unit 4 includes the reference unit 7, a white light source 8, a condenser lens 9, a half mirror 10, a first objective lens 11, a second objective lens 12, an image forming lens 13, and a camera 14.

The white light source 8 is a light source whose emission wavelength band is 400 to 1800 nm. In order for the white light source 8 to operate as a point light source, the opening from which the white light is emitted is set to be sufficiently small. As the white light source 8, it is preferable to use a light source having wavelength of a wide band, such as a halogen lamp, a xenon lamp, a white LED, or an ultrashort pulse laser.

The condenser lens 9 is an optical system that condenses the white light emitted from the white light source 8 onto the half mirror 10, and is arranged to have a focus on the half mirror 10.

The half mirror 10 functions as one example of splitting means (a splitting unit) that splits white light 8A condensed by the condenser lens 9 into two beams of white light (hereinafter referred to as measurement light 8B and reference light 8C), i.e., the white light emitted to the measurement target plane 3 (the measurement light 8B) and the white light emitted to the reference unit 7 (the reference light 8C). Further, the half mirror 10 also functions as one example of combining means (a combining unit) that combines the measurement light 8B emitted to the measurement target plane 3 and thereafter reflected from the measurement target plane 3, and the reference light 8C emitted to the reference unit 7 and thereafter reflected from the inside of the reference unit 7 into white light of one luminous flux (hereinafter referred to as interfering light 8D). That is, the half mirror 10 implements one example of the splitting means and one example of the combining means by one single member. Here, a difference arises between the optical path length of the measurement light 8B after being split and until combined, and the optical path length of the reference light 8C after being split and until combined (hereinafter referred to as the optical path length difference between the measurement light 8B and the reference light 8C). Therefore, in accordance with the optical path length difference between the measurement light 8B and the reference light 8C, the intensity of the interference fringes occurring in the interfering light 8D changes. It is to be noted that, in order for the interference fringes of the interfering light 8D to efficiently be produced, it is desirable that the splitting ratio of the half mirror 10 is set such that the light intensity of the measurement light 8B and that of the reference light 8C becomes substantially one to one.

The first objective lens 11 is an optical system that emits the measurement light 8B to the measurement target plane 3, and is arranged on the opposite side of the condenser lens 9 with reference to the half mirror 10. The measurement target object 2 is placed on the table 6 such that the measurement light 8B emitted from the first objective lens 11 is emitted substantially perpendicularly to the surface of the measurement target plane 3. In other words, the table 6 is arranged such that the optical axis of the measurement light 8B emitted from the first objective lens 11 becomes substantially perpendicular to the flat surface of the table 6.

The second objective lens 12 is an optical system that emits the reference light 8C to the reference unit 7, and is arranged such that the focus position of the second objective lens 12 matches with the focus position of the condenser lens 9 on the half mirror 10.

The reference unit 7 allows the reference light 8C having entered the reference unit 7 from the second objective lens 12 and reflected inside the reference unit 7 to thereafter exit from the reference unit 7. The reference light 8C having exited from the reference unit 7 again enters the second objective lens 12. In this case, the reference unit 7 is set such that the optical path of the reference light 8C entering the reference unit 7 and the optical path of the reference light 8C being output from the reference unit 7 match with each other. It is to be noted that the operation of the reference unit 7 will be described later.

The image forming lens 13 is arranged on the opposite side of the second objective lens 12 with reference to the half mirror 10. The interfering light 8D having entered the image forming lens 13 exits toward the camera 14.

The camera 14 is, as one example, an image pickup apparatus such as a CCD or a CMOS, in which an image pickup element is arranged on a two-dimensional plane. The camera 14 has sensitivity in the waveform band of the white light source 8, and functions as one example of detecting means (a detecting unit) that detects an interference intensity signal. The camera 14 is arranged on the opposite side of the half mirror 10 with reference to the image forming lens 13. The camera 14 images the interfering light 8D in which the interference fringes occur. Further, the camera 14 images an image of the measurement target plane 3 through the image forming lens 13, the half mirror 10, and the first objective lens 11. Further, in association with a change in the optical path length difference of the measurement light 8B and the reference light 8C, an image of the measurement target plane 3 together with the interfering light 8D is imaged for each interval dimension of acquiring the interference intensity signal (hereinafter referred to as the sampling interval dimension). The data acquired by imaging is collected by the control drive system unit 5. It is to be noted that the sampling interval dimension is one pixel unit of the imaging pixel of the camera 14, for example. The sampling interval dimension is a preset and prescribed interval dimension.

Here, a description will be given of the path taken by the white light BA output from the white light source 8. The white light 8A output from the white light source 8 enters the half mirror 10 via the condenser lens 9. The white light 8A having entered the half mirror 10 is split into the measurement light 8B and the reference light BC. Out of the white light split by the half mirror 10 into two white light beams (i.e., the measurement light 8B and the reference light 8C), one of the white light beams (the measurement light 8B) enters the measurement target plane 3 via the first objective lens 11, and thereafter is reflected by the measurement target plane 3 to be condensed by the first objective lens 11, to re-enter the half mirror 10. On the other hand, out of the white light split by the half mirror 10 into two beams (i.e., the measurement light 8B and the reference light 8C), the other one of the white light beams (the reference light 8C) enters the reference unit 7 via the second objective lens 12. While the detail thereof will be described later, the reference light 8C having entered the reference unit 7 is reflected inside the reference unit 7, and thereafter exits from the reference unit 7. The reference light 8C having exited from the reference unit 7 is condensed by the second objective lens 12, and re-enters the half mirror 10. Again, the measurement light 8B and the reference light 8C entering the half mirror 10 are combined into an identical luminous flux by the half mirror 10 (i.e., become the interfering light 8D). The interfering light 8D enters the camera 14 via the image forming lens 13.

Next, a description will be given of the control drive system unit 5. The control drive system unit 5 includes a CPU 16, a storage memory 17 that stores various data such as the interference fringes of the interfering light 8D imaged by the camera 14, calculation results from the CPU 16, and the like, an input apparatus 18 such as a mouse or a keyboard that receives the sampling interval dimension and other setting information, a monitor 19 that displays the measurement result, and a driver apparatus 15 that changes the optical path length difference between the measurement light 8B and the reference light 8C by changing the relative distance between the optical system unit 4 and the measurement target plane 3.

The CPU 16 is a central processing unit that performs a calculation process while generally controlling the entire surface shape measurement apparatus 1. The CPU 16 has functions of an operation control unit 16a shown in FIG. 18 and a calculating unit 16b that performs processing as one example of measuring means (a measuring unit). The operation control unit 16a has a function of controlling the operations of the camera 14, the storage memory 17, and the driver apparatus 15. The calculating unit 16b has a function of acquiring an interference intensity signal based on the interference fringes of the interfering light 8D acquired by the camera 14, and measuring the surface shape of the measurement target plane 3 based on the interference intensity signal. The processing of the operation control unit 16a and the calculating unit 16b will be detailed later. Further, to the CPU 16, the input apparatus 18 and the monitor 19 are connected. Accordingly, the user can input various setting information from the input apparatus 18 and can input required information to the operation control unit 16a and the calculating unit 16b, while observing the operation screen displayed on the monitor 19. Further, on the monitor 19, after the measurement of the measurement target plane 3 is finished, the surface shape of the measured measurement target plane 3 is displayed as an image or a numerical value.

The driver apparatus 15 is provided with a driver mechanism such as a three-axis servo motor which drives the optical system unit 4, relative to the table 6, in the X, Y, Z axis directions which are perpendicular to one another and are shown in FIG. 1A, in accordance with an instruction from the operation control unit 16a of the CPU 16. When the distance between the measurement target plane 3 and the optical system unit 4 becomes shorter by the optical system unit 4 being shifted in the Z axis direction shown in FIG. 1A by the driver apparatus 15 relative to the table 6, the optical path length of the measurement light 8B becomes shorter. Further, when the distance between the measurement target plane 3 and the optical system unit 4 becomes greater, the optical path length of the measurement light 8B becomes longer. On the other hand, even when the distance between the measurement target plane 3 and the optical system unit 4 changes, the optical path length of the reference light 8C does not change. As a result, by the optical system unit 4 shifting in the Z axis direction shown in FIG. 1A, the optical path length difference between the measurement light 8B and the reference light 8C changes. It is to be noted that, instead of causing the optical system unit 4 to shift, the table 6 on which the measurement target object 2 is placed may be shifted in the perpendicular three axial directions. In this case, the optical system unit 4 may be fixed to the installation floor where the surface shape measurement apparatus 1 is installed.

Next, a detailed description will be given of the reference unit 7 included in the optical system unit 4.

The reference unit 7 includes a first diffraction grating and a second diffraction grating 21. The first diffraction grating 20 is arranged at the position near the second objective lens 12 inside the reference unit 7, to diffract and transmit the reference light 8C. The second diffraction grating 21 is arranged in the position farther from the second objective lens 12 than the first diffraction grating 20 is inside the reference unit 7, to diffract and reflect the reference light 8C having been diffracted by and transmitted through the first diffraction grating 20. It is to be noted that, in the drawings, the reflection diffraction grating is shown as being hatched, so as to be clearly distinguished from the transmission diffraction grating.

The reference light 8C having entered the reference unit 7 firstly enters the first diffraction grating 20. The reference light 8C having entered the first diffraction grating 20 is diffracted by the first diffraction grating 20 and transmits through the first diffraction grating 20. The reference light 8C having transmitted through the first diffraction grating 20 subsequently enters the second diffraction grating 21. The reference light 8C having entered the second diffraction grating 21 is diffracted by the second diffraction grating 21 and reflected by the second diffraction grating 21. The reference light 8C reflected by the second diffraction grating 21 again enters the first diffraction grating 20. Again, the reference light 8C having entered the first diffraction grating 20 is diffracted by the first diffraction grating 20 and transmits through the first diffraction grating 20, and thereafter, the reference light 8C exits from the reference unit 7 to the second objective lens 12. In the following description, the reference light 8C entering the reference unit 7 is referred to as the 0th reference light; the 0th reference light having transmitted through the first diffraction grating 20 is referred to as the 1st reference light; the 1st reference light reflected from the second diffraction grating 21 is referred to as the 2nd reference light; and the 2nd reference light having transmitted through the first diffraction grating 20 is referred to as the 3rd reference light.

The first diffraction grating 20 is a transmission diffraction grating and has a plane (a first grating plane 20a) in which a linear grating (grooves) being parallel to the first direction is formed. The first diffraction grating 20 is arranged such that the 0th reference light, which is collimated light obtained by the second objective lens 12, enters in the arrow A direction shown in FIG. 1A. The arrow A direction shown in FIG. 1A is the direction perpendicular to the surface of the first grating plane 20a. Further, the first diffraction grating 20 employs a blazed diffraction grating as one example, and is arranged such that the first direction becomes parallel to the X axis direction shown in FIG. 1A. Further, the first diffraction grating 20 is arranged such that the first grating plane 20a faces the second diffraction grating 21. Accordingly, the 0th reference light is diffracted by the first diffraction grating 20 in the arrow B direction shown in FIG. 1A, and transmits through the first diffraction grating 20 (i.e., the 0th reference light exits in the arrow B direction as the 1st reference light). Further, on the first grating plane 20a, an anti-reflection film is formed so as to suppress occurrence of surface reflection. It is to be noted that, as the anti-reflection film, a general single-layer or multilayer thin anti-reflection film is used. Further, the anti-reflection film that corresponds to the waveform band emitted from the white light source 8 is used.

The second diffraction grating 21 is a reflection diffraction grating, and has a plane (a second grating plane 21a) in which a linear grating (grooves) being parallel to the second direction is formed. The second diffraction grating 21 is arranged such that the 1st reference light enters the second grating plane 21a in the arrow B direction shown in FIG. 1A. Further, the second diffraction grating 21 is a blazed diffraction grating as one example, and is arranged such that the first direction becomes parallel to the X axis direction shown in FIG. 1A, for example. In this case, the grating (grooves) direction of the first diffraction grating 20 and that of the second diffraction grating 21 (i.e., the first direction and the second direction) are in parallel to each other, and the first grating plane 20a and the second grating plane 21a are arranged so as also to be in parallel to each other.

Further, when the grating pitch of the first diffraction grating 20 (a first pitch p₁) is p, the grating pitch of the second diffraction grating 21 (a second pitch p₂) is half as great as p, i.e., p/2. Thus, the 1st reference light having entered the second diffraction grating 21 reflects from the second diffraction grating 21 in the arrow C direction shown in FIG. 1A (the direction opposite to the arrow B direction) (i.e., the 1st reference light exits in the direction opposite to the arrow B direction as the 2nd reference light). That is, the 1st reference light reflected from the second diffraction grating 21 (i.e., the 2nd reference light) re-enters the first diffraction grating 20 while reversely traveling the optical path of the 1st reference light. In other words, the optical path of the 1st reference light having transmitted through the first diffraction grating 20 and thereafter entering the second diffraction grating 21 and the optical path of the 2nd reference light having reflected from the second diffraction grating 21 and thereafter entering the first diffraction grating 20 match with each other. Further, the 2nd reference light re-enters the first diffraction grating 20, whereby the 2nd reference light is further diffracted by the first diffraction grating 20 and transmits through the first diffraction grating 20, and exits from the first diffraction grating 20 in the arrow D direction (i.e., the direction opposite to the arrow A direction) shown in FIG. 1A as the 3rd reference light. In this case, the 2nd reference light having transmitted through the first diffraction grating 20 reversely progresses the optical path of the 0th reference light as the 3rd reference light. That is, the optical path of the 0th reference light entering the reference unit 7 and the optical path of the 3rd reference light exiting from the reference unit 7 match with each other.

Here, it is particularly important to set the conditions of the first diffraction grating 20 and the second diffraction grating 21 such that, the optical path of the 1st reference light having transmitted through the first diffraction grating 20 and thereafter entering the second diffraction grating 21 and the optical path of the 2nd reference light having been reflected from the second diffraction grating 21 and thereafter entering the first diffraction grating 20 match with each other. While the detailed description will be given later, it is for providing the reference light BC with different optical path length difference for each wavelength. It is to be noted that the blazed diffraction grating has its grating plane saw-shaped. Specifically, when the first diffraction grating 20 and the second diffraction grating 21 are each a blazed diffraction grating, it can be represented as shown in FIG. 10. FIG. 10 is an enlarged view of the reference unit 7 shown in FIG. 1A. However, when the blazed diffraction gratings are constantly illustrated, the figures become complicated. Therefore, in some figures, the diffraction gratings may be simplified as the first diffraction grating 20 and the second diffraction grating 21 shown in FIG. 1A.

Here, a description will be given of the structure condition that the first diffraction grating 20 and the second diffraction grating 21 should satisfy.

Generally, when the incident angle to the diffraction grating is θ, the diffraction angle is η, the wavelength of light entering the diffraction grating is λ, the grating pitch of the diffraction grating is p, and the diffraction order is n, the diffraction equation can be expressed by the following Equation (1).

$$sin θ + sin η = n \frac{λ}{p} \qquad ( 1 )$$

From Equation (1), when the incident angle of the 0th reference light entering the first diffraction grating 20 is θ₁, the diffraction angle is η₁, and the first pitch of the first diffraction grating 20 is p₁, the diffraction equation of the first diffraction grating 20 can be expressed by the following Equation (2).

$$sin {θ}_{1} + sin {η}_{1} = n \frac{λ}{{p}_{1}} \qquad ( 2 )$$

Further, from Equation (1), when the incident angle of the 1st reference light entering the second diffraction grating 21 is θ₂, the diffraction angle is η₂ᵣ and the second pitch of the second diffraction grating 21 is p₂, the diffraction equation of the second diffraction grating 21 can be expressed by the following Equation (3):

$$sin {θ}_{2} + sin {η}_{2} = n \frac{λ}{{p}_{2}} \qquad ( 3 )$$

Here, in order for the optical path of the 1st reference light entering the second diffraction grating 21 from the first diffraction grating 20 and the optical path of the 2nd reference light entering the first diffraction grating 20 from the second diffraction grating 21 to match with each other, at least the grating (grooves) direction of the first diffraction grating 20 and that of the second diffraction grating 21 (i.e., the first direction and the second direction) need to be in parallel to each other. Simultaneously, the diffraction angle η₁ of the first diffraction grating 20 and the diffraction angle η₂ of the second diffraction grating 21 need to match with each other. Hence, the diffraction angle η₁ and the diffraction angle η₂ need to satisfy the relationship of the following Equation (4).

η₁=η₂ (4)

By substituting this Equation (4) into Equation (3), the following Equation (5) can be obtained.

$$sin {θ}_{2} + sin {η}_{1} = n \frac{λ}{{p}_{2}} \qquad ( 5 )$$

Here, in the first embodiment, the first diffraction grating 20 and the second diffraction grating 21 are arranged such that the first grating plane 20a and the second grating plane 21a are in parallel to each other. Accordingly, the diffraction angle η₁ of the first diffraction grating 20 and the incident angle η₂ of the second diffraction grating 21 are equal to each other. That is, the diffraction angle η₁ and the incident angle η₂ can be expressed by the relationship of the following Equation (6).

η₁=η₂ (6)

By substituting Equation (6) into Equation (5), the following Equation (7) can be obtained.

$$2 sin {η}_{1} = n \frac{λ}{{p}_{2}} \qquad ( 7 )$$

Next, from Equation (7) and Equation (2), the relationship between the first pitch p₁ of the first diffraction grating 20 and the second pitch p₂ of the second diffraction grating 21 can be expressed by the following Equation (8).

$${p}_{2} = \frac{1}{1 - \frac{{p}_{1} sin {θ}_{1}}{n λ}} \cdot \frac{{p}_{1}}{2} \qquad ( 8 )$$

It is to be noted that, with Equation (8), since the first pitch p₁ and the second pitch p₂ depend on the wavelength, it is not easy to determine the first pitch p₁ and the second pitch p₂ based on Equation (8) in the first embodiment where the white light including a plurality of different wavelengths is used. In particular, since it is necessary to change the second pitch p₂ depending on the position and the wavelength of the reference light entering the second grating plane 21a, it is extremely difficult to prepare a diffraction grating having such a special grating pitch. Further, since the position of the reference light entering the second diffraction grating 21 and the second pitch p₂ at the position where the reference light enters need to accurately match with each other, adjustment of the optical system is extremely difficult. Accordingly, in the first embodiment, the first diffraction grating 20 is installed such that the 0th reference light perpendicularly enters the surface of the first grating plane 20a. Thus, the incident angle η₁ of the reference light entering the first diffraction grating 20 can be set to 0 (rad). Hence, by substituting 0 (rad) into the incident angle η₁ of Equation (6), the relationship between the first pitch p₁ and the second pitch p₂ can be expressed by the following Equation (9).

$${p}_{2} = \frac{{p}_{1}}{2} \qquad ( 9 )$$

From Equation (9), the relationship between the first pitch p₁ and the second pitch p₂ becomes constant irrespective of the wavelength. Therefore, the first diffraction grating 20 and the second diffraction grating 21 satisfying such a relationship can easily be prepared. Further, since it is not necessary to accurately match the wavelength of the reference light at the position where the reference light enters the second diffraction grating 21 and the second pitch p₂, adjustment of the first diffraction grating 20 and the second diffraction grating 21 can easily be performed.

It is to be noted that, in the first embodiment, in order to suppress the loss in the light quantity, the used diffraction order n is 1. Hence, from Equation (1), it is possible to express the diffraction equation in the first diffraction grating 20 by Equation (10).

$$sin {η}_{1} = \frac{λ}{{p}_{1}} \qquad ( 10 )$$

Here, a description will be given of the case where the second grating plane 21a is arranged relative to the first grating plane 20a as being tilted by an angle For the simplicity's sake, the incident angle of the reference light entering the first diffraction grating 20 is referred to as 0 (rad), and the diffraction order n is referred to as 1. Further, since the incident angle η₂ of the reference light to the second diffraction grating 21 is η₁+ψ, Equation (7) in this case can be expressed by the following Equation (11).

$$2 sin ( {η}_{1} + ϕ ) = \frac{λ}{{p}_{2}} \qquad ( 11 )$$

From Equation (11) and Equation (2), it can be seen that the relationship between the first pitch p₁ and the second pitch p₂ depend on the wavelength. Hence, when the second grating plane 21a is arranged as being tilted by the angle ψ relative to the first grating plane 20a, as described above, the first pitch p₁ and the second pitch p₂ cannot easily be determined. Accordingly, the first grating plane 20a and the second grating plane 21a need to be arranged in parallel to each other.

From the foregoing, the conditions that the first diffraction grating 20 and the second diffraction grating 21 should satisfy can be summarized as the following four conditions.

Firstly, the first diffraction grating 20 and the second diffraction grating 21 need to be arranged such that the grating (grooves) direction of the first diffraction grating 20 and that of the second diffraction grating 21 (i.e., the first direction and the second direction) are in parallel to each other.

Secondly, in order to satisfy the relationship of Equation (4), the first grating plane 20a and the second grating plane 21a need to be arranged in parallel to each other.

Thirdly, in order to satisfy the relationship of Equation (6), the first diffraction grating 20 needs to be arranged such that the reference light perpendicularly enters the first grating plane 20a.

Fourthly, in order to satisfy the relationship of Equation (9), the second pitch p₂ of the second diffraction grating 21 needs to be half as great as the first pitch p₁ of the first diffraction grating 20.

Use of the first diffraction grating 20 and the second diffraction grating 21 satisfying the four conditions makes it possible to match the optical path of the 1st reference light entering the second diffraction grating 21 from the first diffraction grating 20 and the optical path of the 2nd reference light entering the first diffraction grating 20 from the second diffraction grating 21 with each other.

Further, by matching the optical path of the 1st reference light and the optical path of the 2nd reference light, the optical path of the 0th reference light entering the first diffraction grating 20 and the optical path of the 3rd reference light exiting from the first diffraction grating 20 also match with each other. This is because, from Equation (1) and Equation (10), the 2nd reference light entering the first diffraction grating 20 at an angle of η₁ becomes the 3rd reference light transmitting through the first diffraction grating 20 by an angle of 0 (rad). It is to be noted that, the angle when the 0th reference light entering the first diffraction grating 20 is 0 (rad).

Next, a description will be given of the difference between the reference light entering the reference unit 7 (i.e., the 0th reference light) and the reference light exiting from the reference unit 7 (i.e., the 3rd reference light).

FIG. 2 shows the manner of light of three wavelengths λ₁, λ₂, and λ₃ included in the 0th reference light and being different from one another, the light being diffracted at both the first diffraction grating 20 and the second diffraction grating 21. In this case, λ₁ to λ₃ satisfy the relationship of the following Equation (12).

λ₁<λ₂<λ₃ (12)

From Equation (10), the diffraction angle η₁ when being diffracted at the first diffraction grating 20 depends on the wavelength. Accordingly, the 0th reference light is split for each wavelength by entering the first diffraction grating 20, and becomes the 1st reference light that progresses different optical path for each wavelength. Further, the diffraction angle n₂ when being diffracted at the second diffraction grating 21 satisfies the relationship of η₁=n₂ from Equation (4). That is, the 1st reference light that progresses different optical path for each wavelength is reflected from the second diffraction grating 21, to thereby become the 2nd reference light that reversely progresses the optical path having been progressed for each wavelength. Specifically, with reference to FIG. 2, the progress direction of the light of the wavelength λ included in the 1st reference light (the arrow B direction shown in FIG. 2) and the progress direction of the light of the wavelength λ₁ included in the 2nd reference light (the arrow C direction shown in FIG. 2) are in the relationship of the directions opposite to each other. The same holds true for the wavelengths λ₂ and λ₃. Here, defining the interval between the first diffraction grating 20 and the second diffraction grating 21 (i.e., the length of the normal from the first grating plane 20a to the second grating plane 21a) is L, the optical path length s₁ between the first diffraction grating 20 and the second diffraction grating 21 at the wavelength λ₁ can be expressed by the following Equation (13) using Equation (10).

$${s}_{1} = \frac{2 L}{cos {η}_{1}} = \frac{2 L}{\sqrt{1 - {( \frac{{λ}_{1}}{p} )}^{2}}} \qquad ( 13 )$$

In connection with the optical path lengths s₁ to s₃ between the first diffraction grating 20 and the second diffraction grating 21 corresponding to the wavelengths λ₁ to λ₃, respectively, the relationship of the following Equation (14) can be derived from Equation (12) and Equation (13).

s₁<s₂<s₃ (14)

That is, from Equation (14), it can be seen that diffraction at both the first diffraction grating 20 and the second diffraction grating 21 provides the optical path length being different for each wavelength. That is, the reference light having exited from the reference unit 7 (the 3rd reference light) is the reference light having entered the reference unit 7 (the 0th reference light) to which the optical path length being different for each wavelength is provided.

In this manner, with such a simple structure in which the transmitting first diffraction grating 20 and the reflective second diffraction grating 21 are combined, the optical path length difference being different for each wavelength can be provided to the reference light 8C. Further, since the first diffraction grating 20 and the second diffraction grating 21 can be arranged as being adjacent to each other, miniaturization of the apparatus can be achieved.

Further, the first diffraction grating 20 is arranged such that the first grating plane 20a is positioned so as to face the second diffraction grating 21. This is to cause the reference light 8C to be diffracted when exiting from the first diffraction grating 20. In this case, since the reference light 8C perpendicularly enters the surface of the first grating plane 20a, it is not affected by the wavelength dispersion of the first diffraction grating 20. It is to be noted that, when the first diffraction grating 20 is arranged such that the first grating plane 20a is positioned to face the second objective lens 12, the reference light 8C is diffracted at the first grating plane 20a, and thereafter enters inside the first diffraction grating 20. Accordingly, the reference light 8C is affected by the wavelength dispersion and the refracting angle changes. Therefore, it is preferable to arrange a correction plate that corrects the change in the refracting angle between the first diffraction grating 20 and the second diffraction grating 21.

It is to be noted that, in the first embodiment, as one example, the dimension of the measurement target plane 3 is set to be a circle whose diameter is 1 mm, and the focal length of the first objective lens 11 and that of the second objective lens 12 are set to be equal to each other. In this case, the luminous flux diameter of the measurement light 8B exiting from the first objective lens 11 and the luminous flux diameter of the reference light BC exiting from the second objective lens 12 each need to have a diameter of at least 1 mm or more. Also, the first grating plane 20a of the first diffraction grating 20 needs to have a diameter of 1 mm or more. In this case, it is preferable that the second grating plane 21a of the second diffraction grating 21 is formed in a dimension which is enough to reflect all the light of the wavelengths used in measurement, out of the light of the wavelengths included in the reference light 8C. Specifically, in the following, a description will be given of the preferable dimension of the second grating plane 21a of the second diffraction grating 21. It is to be noted that, for the purpose of description, the description will be given of the length in the diffraction direction (i.e., the Z axis direction shown in FIG. 2) as the dimension of the second grating plane 21a.

In FIG. 2, out of the wavelengths that are included in the reference light BC and that are used for measurement, the minimum wavelength is referred to as λ₁ (herein, it is referred to as λ_{min.} for the sake of explanation), and the maximum wavelength is referred to as λ₃ (herein, it is referred to as λ_{MAX.} for the sake of explanation). Further, the diffraction angle at the first diffraction grating 20 at the minimum wavelength λ_{min.} is referred to η_{min.}, and the diffraction angle at the first diffraction grating 20 at the maximum wavelength λ_{MAX.} is referred to as η_{MAX.}. Further, the distance between the first diffraction grating 20 and the second diffraction grating 21 (the distance of the normal from the first grating plane 20a to the second grating plane 21a) is referred to as L. The reference light 8C of the minimum wavelength λ_{min.} enters the second diffraction grating 21 as being displaced in the diffraction direction (the Z axis direction shown in FIG. 2) by Ltanη_{min.} from the output position in the first grating plane 20a. On the other hand, the reference light 8C of the maximum wavelength enters the second diffraction grating 21 as being displaced in the diffraction direction (the Z axis direction shown in FIG. 2) by Ltanη_{MAX.} from the output position in the first grating plane 20a. That is, when the length of the second grating plane 21a relative to the diffraction direction is S, the relationship expressed by the following Equation (15) can be obtained.

L tan η_{MAX.}−L tan η_{min.}≦S (15)

In Equation (15), tan η_{min.} and tan_{ηMAX.} can be obtained from Equation (10). Further, when the diameter of the luminous flux of the reference light 8C entering the first diffraction grating 20 is r, it is desirable that it is expressed by Equation (16). This is for reflecting greater reference light 8C to thereby avoid a reduction in the light quantity.

L tan η_{MAX.}−L tan η_{min.}+r≦S (16)

By arranging the second diffraction grating 21 having the second grating plane 21a that satisfies the condition of Equation (16) at the position where the reference light 8C having the minimum wavelength λ_{min.} and having transmitted through the first diffraction grating 20 enters, out of the wavelengths included in the reference light 8C, the minimum wavelength to the maximum wavelength used for measurement can efficiently be diffracted and reflected.

It is to be noted that, in the first embodiment, as one example, the first pitch p₁ of the first diffraction grating 20 is set to 12 μm, the second pitch p₂ of the second diffraction grating 21 is set to 6 μm, and the distance L between the first diffraction grating 20 and the second diffraction grating 21 is set to 50 mm.

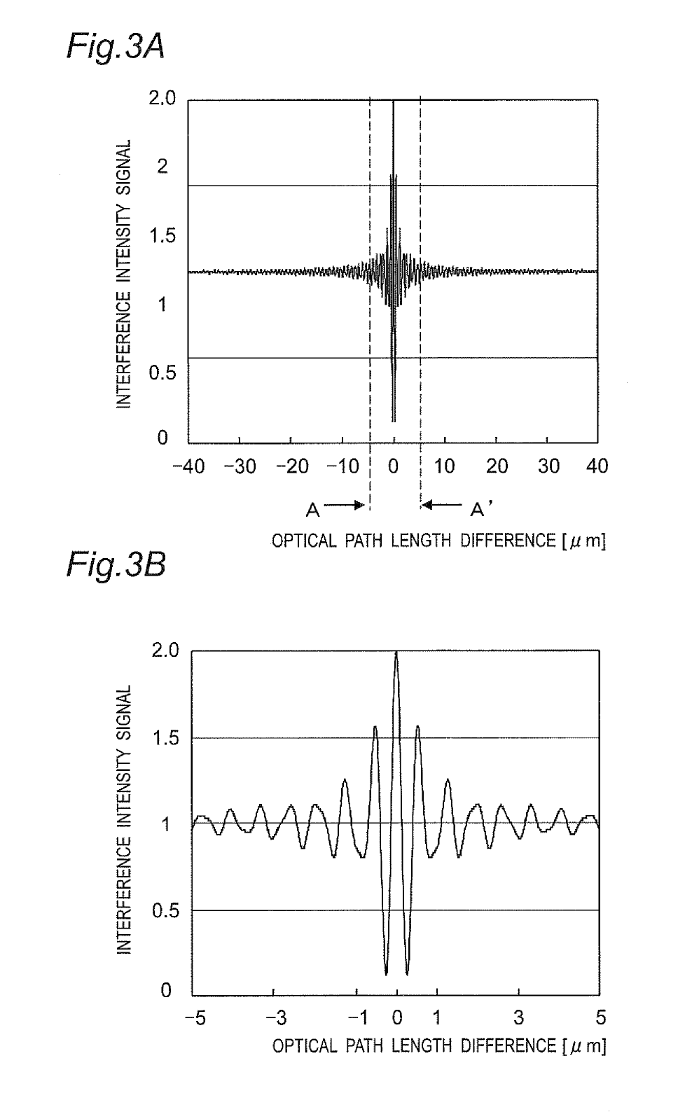

Here, prior to describing the method of measuring the measurement target plane 3 using the reference light 8C provided with a different optical path length for each wavelength, firstly, a description will be given of a method of using reference light which is not provided with a different optical path length difference for each wavelength, that is, the conventional surface shape measurement method. In connection with the conventional surface shape measurement method, FIGS. 3A and 3B are each a graph showing the relationship of the interference intensity signal which is detected when the optical path length difference between the measurement light and the reference light is changed. Here, for the purpose of experiment, the waveform band of the white light source 8 is set to have a uniform intensity distribution of 400 to 700 nm. In FIGS. 3A and 3B, the vertical axis indicates the interference intensity signal of the detected interfering light, and the horizontal axis indicates the optical path length difference between the measurement light and the reference light. It is to be noted that, the optical path length difference being negative indicates that the optical path length of the reference light is longer than the optical path length of the measurement light. Further, the optical path length difference being positive indicates that the optical path length of the measurement light is longer than the optical path length of the reference light. Further, FIG. 3A shows the relationship of the interference intensity signal in the case where the optical path length difference between the measurement light and the reference light is −40 to 40 μm. Further, FIG. 3B is an enlarged view of the range shown in FIG. 3A in which the optical path length difference between the measurement light and the reference light is −5 to 5 μm (the range A-AF shown in FIG. 3A). From FIG. 3B, the peak of the interference intensity signal can clearly be seen only in the range where the optical path length difference between the measurement light and the reference light is in the range of −1 to 1 μm.

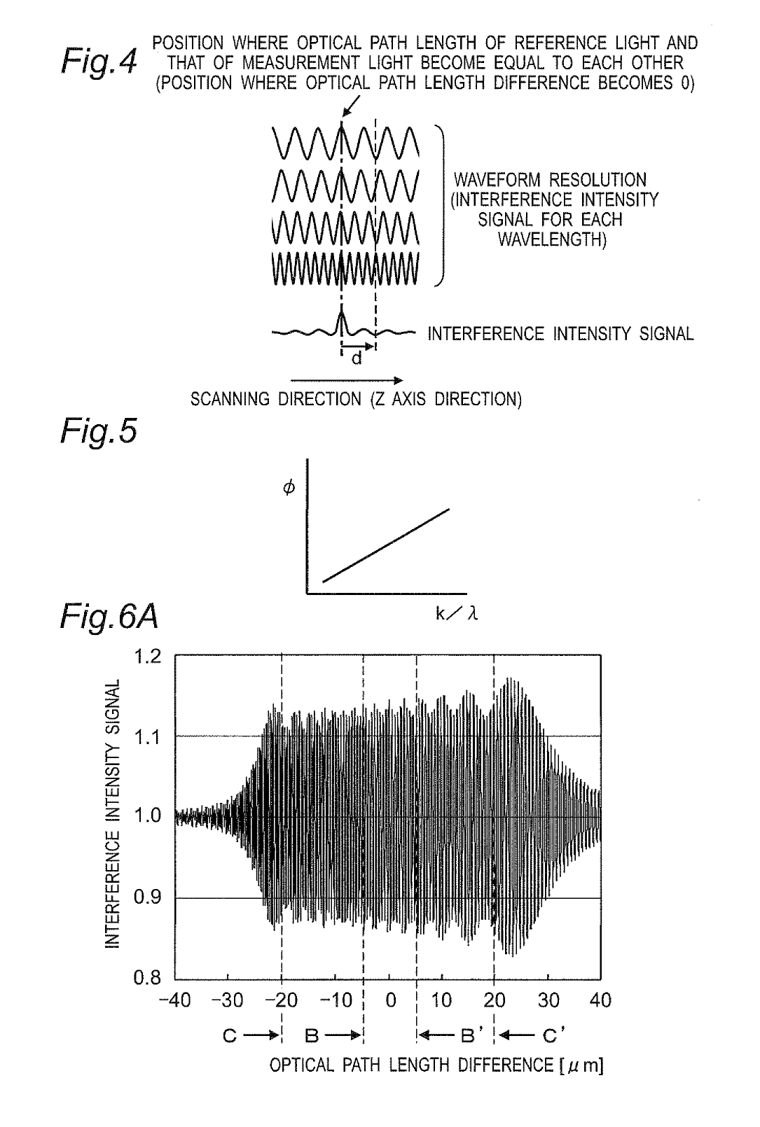

Further, the interference intensity signal shown in FIGS. 3A and 3B are detected, as shown in FIG. 4, as superposition of the interference intensity signals of respective wavelengths included in the white light source 8. Hence, using Fourier transform, the detected interference intensity signal can be resolved for each sine wave. Thus, the interference intensity signal for each wavelength can be obtained.

Further, in FIG. 4, when the position where the optical path length difference between the measurement light and the reference light becomes 0 is the measurement reference, the phase φ (rad) of the interference intensity signal of the wavelength λ at the measurement target plane 3 at the position being different from the measurement reference by a distance d can be obtained from the following Equation (17) where k is a constant.

$$φ = k \frac{d}{λ} \qquad ( 17 )$$

In this case, since the optical path between the measurement reference and the measurement target plane is the reflective optical path, a change in the optical path length is twice as great as the distance d. With the interference, a sine wave is obtained whose one cycle is λ/2. That is, k=η/2. Here, a graph whose coordinates are the horizontal axis being k/λ and the vertical axis being the phase φ of the interference intensity signal can be represented by a straight line having a gradient d as shown in FIG. 5. According to the conventional surface shape measurement method, from this gradient d, the distance d from the measurement reference of the measurement target plane 3 can be obtained.

According to such a conventional surface shape measurement method, in the case where the optical path length difference between the measurement light and the reference light becomes the zero position (i.e., the measurement reference), the phases of the interference intensity signals of respective wavelengths match with one another, and are detected as the peak of the interference intensity signal. On the other hand, at the position where there is the optical path length difference between the measurement light and the reference light (i.e., at the position that is not the measurement reference), the interference intensity of the wavelengths cancel out one another, and the interference intensity signal almost vanishes. Therefore, the interference intensity signal can only be detected within a limited narrow range. Provided that the conventional surface shape measurement method is performed with the surface shape measurement apparatus 1 shown in FIG. 1A, the shape of the measurement target plane 3 cannot be measured unless the relative distance between the optical system unit 4 and the measurement target plane is at the substantial reference position (i.e., at the position where the optical path length difference between the measurement light and the reference light becomes zero).

Further, in the case where the interference intensity signal cannot be detected unless the relative distance between the optical system unit 4 and the measurement target plane 3 is at the substantial reference position, since it is unknown as to at which position the interference intensity signal is detected, the sampling interval dimension for acquiring the interference intensity signal in the scanning direction must be finely reduced in order also to use Fourier transform. Accordingly, as the convex and concave of the surface shape of the measurement target plane 3 are greater, the scanning range must be widened. This not only increases the measuring time but also the number of pieces of data to be processed, and hence much data processing time becomes necessary. Further, even when there are enormous data pieces acquired by such a finely reduced sampling interval dimension, the effective data pieces that can be used in measurement are only a few part of the data pieces. This is because the data in the region where the peak of the interference intensity signal is not present is useless data in which amplitude is almost zero. Since such useless data occupies most of the sampled interference intensity signals, it is poor in efficiency and puts an excessive burden to the control means such as the CPU 16 that performs processing.

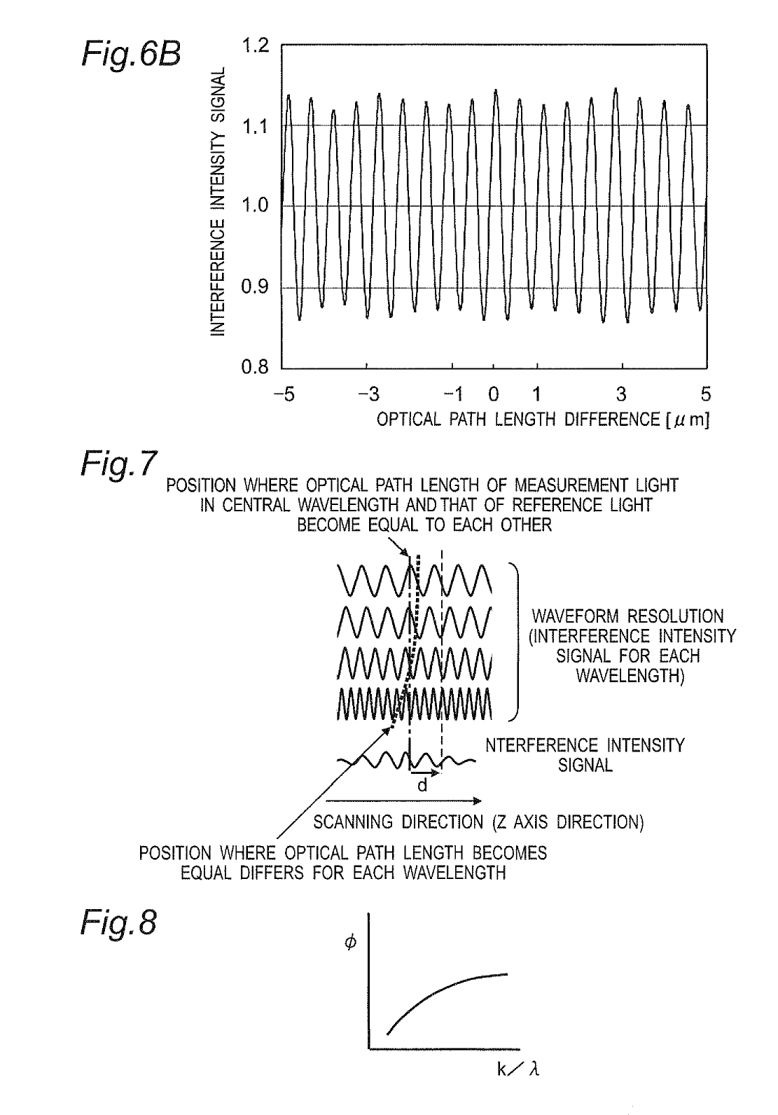

In contrast to such a conventional surface shape measurement method, a description will be given of the surface shape measurement method according to the first embodiment performed using the surface shape measurement apparatus 1 shown in FIG. 1A. FIGS. 6A and 6B are each a graph showing the relationship of the interference intensity signal detected when the measurement target plane is scanned in the Z axis direction using the surface shape measurement apparatus 1. In this case, for the purpose of experiment, the waveform band of the white light source 8 is set to have a uniform intensity distribution of 400 to 700 nm. In FIGS. 6A and 6B, the vertical axis indicates the interference intensity signal of the detected interfering light, and the horizontal axis indicates the optical path length difference between the measurement light and the reference light. In this case, the distance from the half mirror 10 to the second diffraction grating 21 is set to be substantially equal to the distance from the half mirror 10 to the measurement target plane 3, based on the central wavelength (550 nm) of the white light that the white light source 8 emits. Accordingly, in the central wavelength of the white light that the white light source 8 emits, the measurement reference is set at the position where the optical path length difference between the measurement light 8B and the reference light 8C becomes zero. It is to be noted that, the optical path length difference being negative indicates that the optical path length difference of the reference light 8C is longer than the optical path length difference of the measurement light 8B, and the optical path length difference being positive indicates that the optical path length of the measurement light 8B is longer than the optical path length of the reference light 8C. Further, FIG. 6B shows the relationship of the interference intensity signal in the case where the optical path length difference between the measurement light 8B and the reference light 8C is −40 to 40 μm. FIG. 6B is an enlarged view of the range shown in FIG. 6A in which the optical path length difference between the measurement light 8B and the reference light 8C is −5 to 5 μm (the range B-B′ shown in FIG. 6A). From FIG. 6B, it can be seen that the interference intensity signal can be detected in the wider range as compared to the conventional surface shape measurement method. Further, from FIG. 6A, it can be seen that the interference intensity signal can fully be recognized even in the range where the optical path length difference between the measurement light 8B and the reference light 8C is −20 to 20 μm (the range C-C′ shown in FIG. 6A). This is because, as shown in FIG. 7, a different optical path length is provided for each wavelength to the reference light 8C by the reference unit 7. Describing it in detail, since the interference is caused to occur in the reference light 8C which is provided with the different optical path length for each wavelength, the peak of the interference intensity signal appears at the position which is different for each wavelength.

Further, the interference intensity signal obtained in FIG. 6A can be resolved by Fourier transform into interference intensity signals of respective wavelengths. In this case, the phase p (rad) of the interference intensity signal at the wavelength λ at the measurement target plane 3 at the position away from the measurement reference (i.e., the position where the optical path length difference between the measurement light 8B and the reference light 8C becomes zero) by the distance d can be obtained from the following Equation.

$$φ = k \frac{d + s}{λ} \qquad ( 18 )$$

In Equation (18), k=η/2, similarly to Equation (17). In this case, since the reference light 8C is provided with the different optical path length difference for each wavelength, being different from Equation (17), the phase φ of the interference intensity signal depends on the optical path length s which is provided for each wavelength of the reference light 8C. It is to be noted that the optical path length s can be obtained from Equation (13).

Based on Equation (18), FIG. 8 is a graph whose coordinate axes are the horizontal axis being k/λ and the vertical axis being the phase φ. The reason why the graph of FIG. 8 shows a curve being different from FIG. 5 is because of the effect of the optical path length s provided for each wavelength. Accordingly, in order to obtain the distance d from the measurement reference from the curve, the effect of the optical path length s provided for each wavelength may be eliminated. Specifically, it is possible to obtain the distance d from the measurement reference from the gradient of an approximated straight line which is obtained through straight line approximation performed by: using the distance L between the first diffraction grating 20 and the second diffraction grating 21 previously measured and the first pitch p₁ of the first diffraction grating 20; and approximating a straight line from Equation (13) and Equation (18) using the method of non-linear least squares or the like. The height of the measurement target plane 3 can be measured by adding the position of the measurement reference from the reference plane 6a to the distance d.

In this manner, use of the surface shape measurement apparatus 1 enables detection of the interference intensity signal even when the optical path length difference between the measurement light and the reference light is great. Accordingly, the sampling interval dimension in the scanning direction can be widened, and acceleration of measurement can be achieved.

It is to be noted that, when the position of the reference plane 6a is matched with the surface of the table 6, it is preferable to set the measurement reference as the initial condition such that the position C shown in FIG. 6A matches with the reference plane 6a. The position C shown in FIG. 6A is the position where the interference intensity signal can be detected. The position C is the position where the optical path length difference between the measurement light and the reference light becomes the maximum and the position where the optical path length of the measurement light becomes longer than the optical path length of the reference light. Since the region where the interference intensity signal can be detected can effectively be used, the surface shape of the measurement target plane 3 can be measured at high speeds. Specifically, by setting the measurement reference at the position being displaced by 20 μm from the surface of the table 6 in the height direction (i.e., the Z axis direction shown in FIG. 1A), the surface shape of the measurement target plane 3 is measured.

Further, in the case where the average height of the measurement target object 2 is set to the position of the reference plane 6a, it is preferable that the reference plane 6a and the position of the measurement reference match with each other. Specifically, the measurement reference as the initial condition is set such that the optical path length of the measurement light 8B and the optical path length of the reference light 8C match with each other at the reference plane Ga. Thus, the range in which the interference intensity signal can be detected can efficiently be used. Therefore, the surface shape of the measurement target plane 3 can be measured at high speeds.

Next, how fast the measurement can be carried out using the surface shape measurement apparatus 1 according to the first embodiment as compared to the conventional surface shape measurement method will be described, using specific numerical values.

From FIG. 3B, according to the conventional surface shape measurement method, the interference intensity signal can only be detected when the optical path length difference between the measurement light and the reference light is in the range of approximately 2 μm (−1 to 1 μm). On the other hand, with the surface shape measurement apparatus 1, as can be seen from FIG. 6A, the interference intensity signal can be detected when the optical path length difference between the measurement light and the reference light is approximately 40 μm (−20 to 20 μm). That is, use of the surface shape measurement apparatus 1 according to the first embodiment enables detection of the interference intensity signal in an approximately twenty times greater range as compared to the conventional range, in connection with the optical path length difference between the measurement light 8B and the reference light 8C.

Further, in order to clarify the difference between the conventional surface shape measurement method and the surface shape measurement method using the surface shape measurement apparatus 1 according to the first embodiment, a description will be given of the case where the measurement target plane 3 having a convex and concave shape of 40 μm formed on its surface is measured. According to the conventional surface shape measurement method, unless the optical path length difference between the measurement light and the reference light is not in a range of 2 μm, the interference intensity signal cannot be detected. Accordingly, in order to detect the convex and concave shape of 40 μm, it is necessary to measure including the range in which the interference intensity signal occurs, and at least the range of 45 μm needs to be scanned. Further, in order to precisely detect the surface shape of the measurement target plane 3, for example, in the case where 100 types of relationship of the optical path length differences and the interference intensity are to be detected, that is, when sampling is performed for 100 times, since the range in which the interference intensities signal can be detected is 2 μm, the sampling interval dimension becomes 0.02 μm. Since the scanning range is 45 μm, the number of sampling over the entire range is 2250. That is, in order to acquire effective 100 data pieces, sampling needs to be performed for 2250 times according to the conventional surface shape measurement method.

On the other hand, with the surface shape measurement apparatus 1 according to the first embodiment, since the interference intensity signal can be detected within a range of −20 μm to 20 μm, the range including the entire measurement target plane 3 can be detected at once. Further, since sampling is performed for 100 times for detecting the range of 40 μm, the sampling interval dimension is 0.4 μm. Here, the number of sampling over the entire range becomes also 100. That is, sampling should be performed for 100 times for acquiring effective 100 data pieces. Accordingly, as compared to the conventional surface shape measurement method in which sampling of 2250 times must be performed, the surface shape measurement apparatus 1 according to the first embodiment can perform measurement at the speed 22.5 times higher than that. From the foregoing, use of the surface shape measurement apparatus 1 enables acceleration as compared to the conventional surface shape measurement method.

Further, for example, in the case where sampling is carried out for 2250 times with the surface shape measurement apparatus 1, in which the sampling interval dimension is 0.02 μm, the number of acquired data pieces is 2250. Since it is possible to detect the interference intensity signal for every acquired data piece, 2250 types of relationship of the optical path length differences and the interference intensity signals can be sampled. Accordingly, with the surface shape measurement apparatus 1, when measurement is performed with the same sampling interval dimension as the conventional surface shape measurement method, the surface of the measurement target plane 3 can be measured by the data pieces 22.5 times as great in number as that of the conventional manner. That is, measurement with the same sampling interval dimension as the conventional method using the surface shape measurement apparatus 1 can improve the measurement precision.

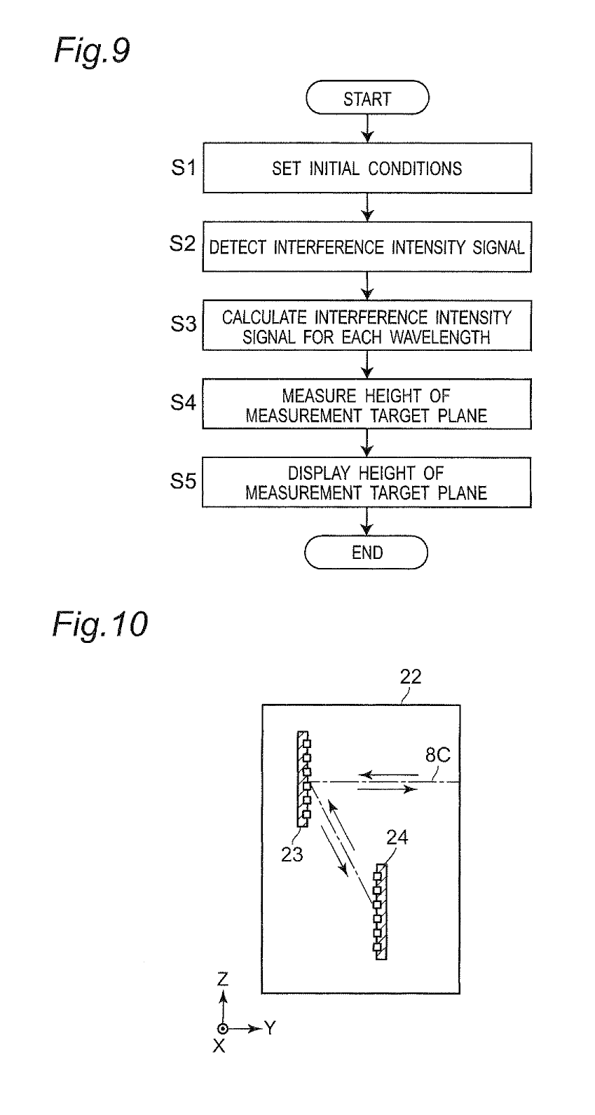

Next, with reference to FIGS. 1A, 1B, and 9, a description will be given of a flowchart of the process performed by the surface shape measurement apparatus 1.

In Step S1, the CPU 16 sets the initial conditions such as the sampling interval dimension, the position of the reference plane 6a, the position of the measurement reference, the initial position of the optical system unit 4, and the like. It is to be noted that, in Step S1, the initial conditions may be set by the manipulation of the input apparatus 18 by the user, or it may previously be set in the storage memory 17.

Next, in Step S2, the interference intensity signal is detected by the camera 14 at the set sampling interval dimension. Here, the operation control unit 16a of the CPU 16 provides an instruction of change start to the driver apparatus 15 for causing the optical system unit 4 to shift in the Z axis direction shown in FIG. 1A. According to the instruction from the operation control unit 16a of the CPU 16, the driver apparatus 15 shifts the optical system unit 4 in the Z axis direction relative to the table 6. Thus, the optical path length difference between the measurement light 8B and the reference light 8C changes. Further, at this time, the operation control unit 16a of the CPU 16 further detects the interference intensity signal of the interfering light by the camera 14 every time the optical system unit 4 shifts by the sampling interval dimension set in Step S1, and successively stores the detection results in the storage memory 17. Further, the storage memory 17 associates, based on the value from a not-shown encoder attached to the servo motor of the driver apparatus 15, an interference intensity signal and the position from the reference plane 6a in the Z axis direction where the interference intensity signal is corresponded to each other, and are stored. It is to be noted that, the positions in the X axis direction and the Y axis direction perpendicular to the Z axis direction are also stored in the storage memory 17 based on the not-shown encoder attached to the servo motor of the driver apparatus 15.

Next, in Step S3, the calculating unit 16b of the CPU 16 performs Fourier transform for the interference intensity signal detected by the camera 14, and calculates the interference intensity signal for each wavelength.

Next, in Step S4, based on the interference intensity signal for each wavelength calculated by the calculating unit 16b of the CPU 16, the position from the reference plane 6a in the Z axis direction of the measurement target plane 3 is measured. Specifically, the calculating unit 16b of the CPU 16 uses Equation (13) and Equation (18) to thereby calculate the position in the Z axis direction from the reference plane 6a of the measurement target plane 3.

Next, in Step 95, the position in the Z axis direction from the reference plane 6a of the measurement target plane 3 calculated by the calculating unit 16b of the CPU 16, that is, the height of the measurement target plane 3 is displayed on the monitor 19.

As described above, use of the surface shape measurement apparatus 1 enables detection of the interference intensity signal even when the positional relationship of the measurement target plane 3 and the optical system unit 4 is the positional relationship being away from the measurement reference (i.e., the position where the optical path length difference between the measurement light 8B and the reference light 8C is zero). That is, since the interference intensity signal can be detected even in the case where the optical path length difference between the measurement light 8B and the reference light 8C is great, the surface shape measurement apparatus 1 can detect the surface shape at high speeds.

It is to be noted that, the driver apparatus 15 is not limited to the servo motor, and a piezoelectric element or a stepper motor may be used.

It is to be noted that, with a wider waveform band of the white light source 8, the range of the horizontal axis k/λ of the graph shown in FIG. 8 can be taken wider and, therefore, the measurement precision can be improved. However, generally, widening the waveform band of the white light source 8 narrows the range in which the interference intensity signal can be detected. On the other hand, with the surface shape measurement apparatus 1, even when the waveform band of the white light source 8 is widened, the range in which the interference intensity signal can be detected is fully wide and, therefore, an improvement in the measurement precision can be achieved while suppressing a reduction in the measurement speeds.

It is to be noted that, an increase in the interval L between the first diffraction grating 20 and the second diffraction grating 21 can widen the range of the optical path length difference between the measurement light and the reference light in which the interference intensity signal can be detected. This is because the optical path length provided for each wavelength becomes great. Using this phenomenon, the first diffraction grating 20 and the second diffraction grating 21 should be adjusted such that the interference intensity signal can be detected in a range wider than the convex and concave shape formed in the Z axis direction of the measurement target plane 3. Thus, by simply scanning the range narrower than the range in which convex and concave are formed, the surface shape can be measured and a reduction in the measurement time can be achieved.

It is to be noted that, in FIG. 1A, though the reflection angle at the half mirror 10 is shown to be 90°, the angle may be changed in the range in which the components structuring the optical system unit 4 are not brought into contact with one another.

It is to be noted that, the cross-sectional shape of the first diffraction grating 20 and the second diffraction grating 21 is saw-shaped (blazed), whereby the diffraction light solely in the necessary direction (in the first embodiment, the first order diffraction light) can be obtained, and loss in the light quantity and the stray light attributed to the unnecessary diffraction light (the light except for the first order diffraction light) are minimized. It is to be noted that, though the cross-sectional shape of the diffraction gratings can be a sinusoidal shape or a rectangular shape, this will produce unnecessary diffraction light. Therefore, in the case where the sinusoidal shape or the rectangular shape is used, a means for eliminating the unnecessary diffraction light so as not to enter the camera 14 must separately be provided.

It is to be noted that, though the description has been given that the grating (grooves) direction of the first diffraction grating 20 and the grating (grooves) direction of the second diffraction grating 21 are parallel to the X axis direction shown in FIG. 1A, the first diffraction grating 20 and the second diffraction grating are only required to be arranged such that their respective grating (grooves) directions are parallel to each other. For example, the first diffraction grating 20 and the second diffraction grating 21 may be arranged such that the grating (grooves) direction of the first diffraction grating 20 and the grating (grooves) direction of the second diffraction grating 21 are both in parallel to the Z axis direction. In this case, the diffraction direction of the reference light 8C becomes the X axis direction shown in FIG. 1A.

It is to be noted that, though the optical system unit 4 is scanned in the Z axis direction so as to obtain the interference intensity signal, the reference unit 7 may be shifted in the Y axis direction by the driver apparatus 15, to thereby change the optical path length difference between the measurement light 8B and the reference light 8C.

Here, a description will be given of a variation of the reference unit 7. The variation includes the first diffraction grating 20 and the second diffraction grating 21 as being integrally structured as a diffraction grating 200 being one single member. Specifically, as shown in FIG. 1D, as the diffraction grating 200, a first grating plane 201 and a second grating plane 202 are formed on two planes of a substrate 203 which is a transparent flat substrate, the two planes being in parallel to each other. The first grating plane 201 corresponds to the first grating plane 20a of the first diffraction grating 20. Further, the second grating plane 202 corresponds to the second grating plane 21a of the second diffraction grating 21. That is, the conditions that the first grating plane 201 and the second grating plane 202 should satisfy are identical to the conditions that the first diffraction grating 20 and the second diffraction grating 21 should satisfy as described in the foregoing. It is to be noted that, in FIG. 1D, it is clearly illustrated that the first grating plane 201 and the second grating plane 202 are each a blazed diffraction grating. Further, the first grating plane 201 functions as the transmission diffraction grating, and the second grating plane 202 functions as the reflection diffraction grating.

According to this variation, measurement can be performed functionally similarly to the manner in which the first diffraction grating 20 and the second diffraction grating 21 are structured by forming the grating planes of the diffraction gratings at two substrates, respectively.

By forming the first grating plane 201 and the second grating plane 202 on the opposite faces of one substrate 203, variations in the distance between the grating planes and in the direction in parallel to the grating plane can be suppressed to the minimum possible extent. Variations in the distance between the grating planes invite a change in the optical path length in each wavelength, which invites an error in measuring the height. Further, variations in the direction parallel to the grating plane invite variations in the interference signal intensity. Specifically, a measurement error in performing the spectrum resolution for each wavelength is invited in calculating the height of the measurement target plane 3. Accordingly, by forming the grating plane on each of the opposite faces of one substrate 203, the factors of such variations can be minimized, and a reduction in the measurement precision can be prevented.

On the other hand, when the diffraction gratings (grating planes) are formed at two separate substrates, the distance between the grating planes can easily be widened. When the distance between the grating planes is excessively narrow, ±first order diffraction light cannot be split, and the ±first order diffraction light may be mixed with each other. In this case, when the optical path length difference approaches half the wavelength, the intensity of the reference light 8C becomes extremely small, and the interference intensity signal may be detected very little and cannot be measured. That is, forming the diffraction gratings (grating planes) at two separate substrates, the distance enough to split the ±first order diffraction light can easily be adjusted.

### Second Embodiment

The structure of a surface shape measurement apparatus according to a second embodiment itself is substantially the same as the surface shape measurement apparatus 1 according to the first embodiment and, therefore, a description of the structure itself is not given herein. As shown in FIG. 1E, the CPU 16 includes the operation control unit 16a and the calculating unit 16c. The only difference from the first embodiment is the calculation process performed by the calculating unit 16c of the CPU 16 for detecting the position in the Z axis direction of the measurement target plane 3 from the interference intensity signal. The calculation process will be described in the following.

The non-linear portion k×s/λ of Equation (18) can be eliminated by the calculating unit 16c of the CPU 16 through using the data imaged by the camera 14. The phase of the signal obtained by the interference intensity signal detected by each image pickup element included in the camera 14 is φⱼ; the average value of the phase obtained by the interference intensity signals detected by the whole image pickup elements included in the camera 14 is φ_{avr.}; the distance from the measurement reference of the measurement target plane 3 corresponding to each image pickup element (the position where the optical path length difference between the measurement light and the reference light becomes zero) is dⱼ; and the number of pieces of data is m. In this case, since the optical path length s does not depend on the image pickup element, Equation (18) can be expressed by the following Equation (19).

$${φ}_{avr .} = \sum k ( \frac{{d}_{j} + s}{λ} ) ( \frac{1}{m} ) = k \sum ( \frac{{d}_{j} + s}{m} ) ( \frac{1}{λ} ) + k \frac{s}{λ} \qquad ( 19 )$$

Σ in Equation (19) represents the sum. When k×s/λ is eliminated from Equation (19) by the calculation performed by the calculating unit 16c of the CPU 16, it can be expressed by the following Equation (20).

$${φ}_{j} = k ( \frac{{d}_{j} - \sum \frac{{d}_{j}}{m}}{λ} ) + {φ}_{avr .} \qquad ( 20 )$$

Since Σdⱼ/m and φ_{avr.} in Equation (20) are constants, the graph prepared based on Equation (20) provides a straight line. From the gradient of the straight line, the calculating unit 16c of the CPU 16 can obtain the distance dⱼ from the measurement reference of the measurement target plane 3.

The calculating unit 16c of the CPU 16 performing such a process can convert the curve graph as shown in FIG. 8 which is under the effect of the optical path, length of each wavelength provided by the reference unit 7 into a straight line by the calculation. Thus, calculation of obtaining the distance dⱼ from the measurement reference of the measurement target plane 3 can be simplified and the calculation time can be shortened.

It is to be noted that, though the average value of the phase obtained by the interference intensity signals detected by the entire image pickup elements is used by the calculating unit 16c of the CPU 16 in order to eliminate the non-linear portion k×s/λ, it is also possible to use a particular image pickup element or a plurality of image pickup elements being part of the entire image pickup elements of the camera 14, to thereby reduce the calculation amount.

### Third Embodiment

A surface shape measurement apparatus according to a third embodiment corresponds to the surface shape measurement apparatus 1 according to the first embodiment whose reference unit 7 is replaced by a reference unit 22 of a different structure. In the following, a description will solely be given of the different structure. Further, in the following description, the first diffraction grating refers to the diffraction grating that the reference light having entered the reference unit firstly enters. Further, the second diffraction grating refers to the diffraction grating that the reference light enters after the first diffraction grating.

FIG. 10 shows the reference unit 22 according to the third embodiment. In the reference unit 22, the transmission first diffraction grating 20 of the reference unit 7 according to the first embodiment is replaced by a reflection first diffraction grating 23. Further, in the reference unit 22, the reflection second diffraction grating 21 of the reference unit 7 according to the first embodiment is replaced by a reflection second diffraction grating 24. Further, the second pitch p₂ of the second diffraction grating 24 is the grating pitch half as great as the first pitch p₁ of the first diffraction grating 23.

Further, the relationship between the first diffraction grating 23 and the second diffraction grating is the same as the relationship between the first diffraction grating 20 and the second diffraction grating 21 according to the first embodiment. Thus, provision of the reflection diffraction gratings can reduce the attenuation attributed to the transmission of the reference light 8C which occurs when the transmission diffraction grating is used. Accordingly, it becomes possible to detect clearer interfering light, and to improve the precision of the measurement.

However, since it is necessary to secure the wider interval L of the diffraction gratings than the case where the transmission diffraction grating is used, it is preferable to use the reference unit 7 according to the first embodiment when the chief purpose is miniaturization of the apparatus. It is to be noted that, when it is necessary to increase the light quantity of the reference light 8C, it is preferable to use the reference unit 22 according to the third embodiment. It is to be noted that the reference unit 22 according to the third embodiment may be used for the surface shape measurement apparatus according to the second embodiment.

### Fourth Embodiment

A surface shape measurement apparatus according to a fourth embodiment corresponds to the surface shape measurement apparatus 1 according to the first embodiment whose reference unit 7 is replaced by a reference unit 25 of different structure. In the following, a description will solely be given of the structure being different from the first embodiment.

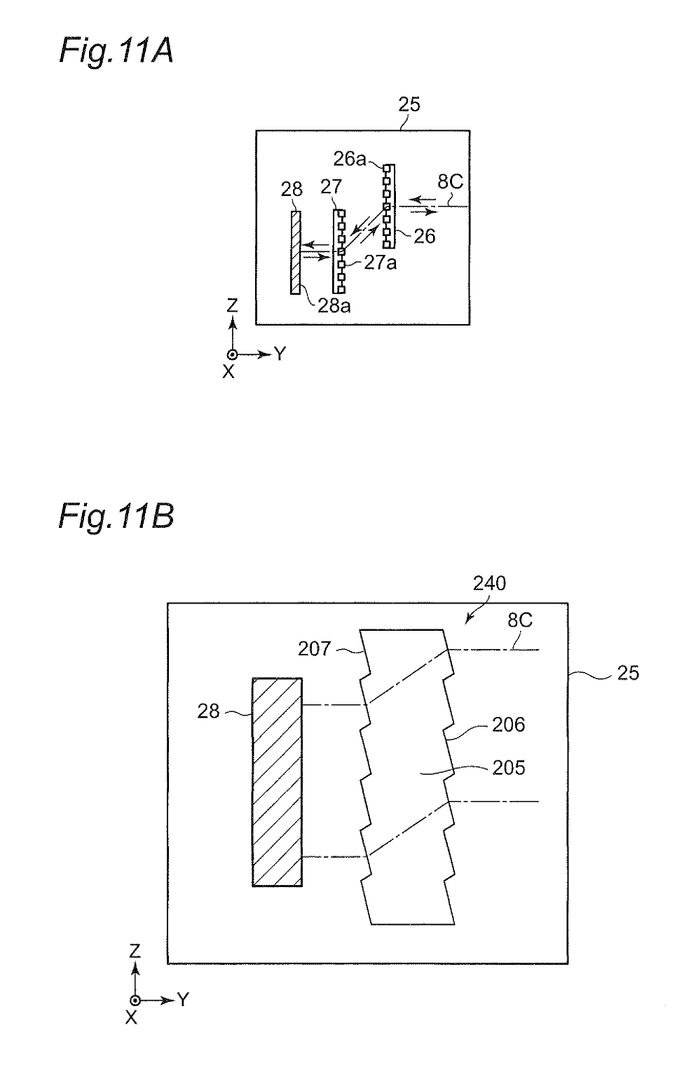

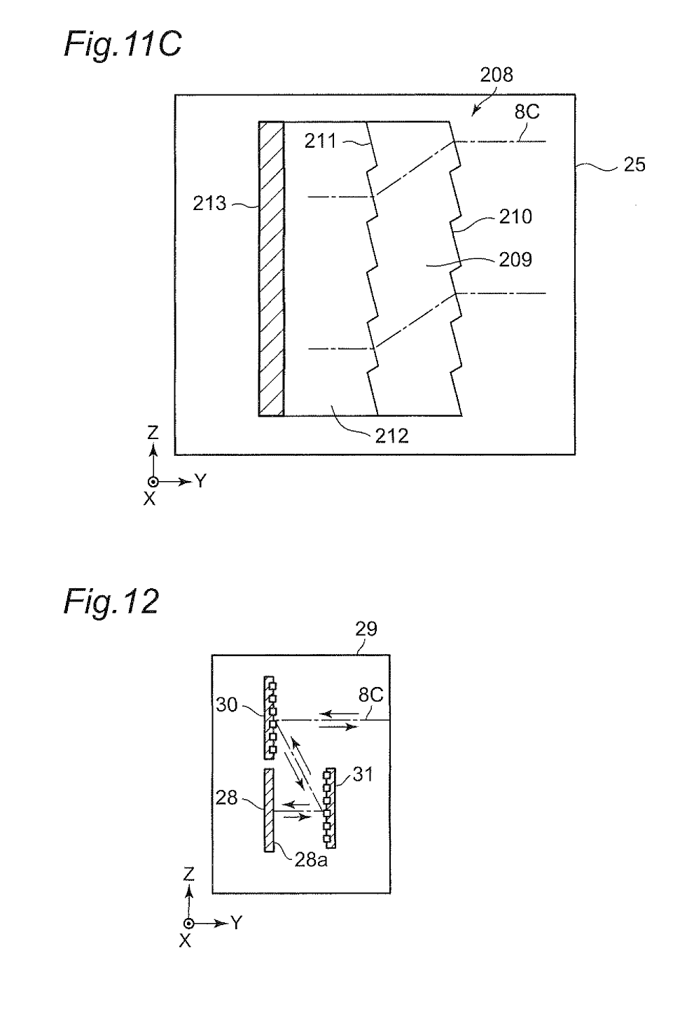

FIG. 11A shows the reference unit 25 according to the fourth embodiment. In the reference unit 25, the transmission first diffraction grating 20 and the reflection second diffraction grating 21 of the reference unit 7 according to the first embodiment are replaced by a transmission first diffraction grating 26 and a transmission second diffraction grating 27. Further, the reference unit 25 includes a reference mirror 28 that reflects the reference light 8C having transmitted through the second diffraction grating 27 to reversely progress the optical path of the reference light 8C. Further, the first diffraction grating 26 includes a first grating plane 26a being a plane where the linear grating (grooves) being parallel to the first direction is formed. Further, the second diffraction grating 27 includes a second grating plane 27a being a plane where the linear grating (grooves) being parallel to the second direction is formed. Further, the reference mirror 28 includes a reflection plane 28a where a mirror plane is formed on the plane.

The reference light 8C having entered the reference unit 25 is firstly diffracted by and transmits through the first diffraction grating 26. The reference light 8C having transmitted through the first diffraction grating 26 subsequently enters the second diffraction grating 27. The reference light 8C having entered the second diffraction grating 27 is diffracted by and transmits through the second diffraction grating 27. The reference light 8C having transmitted through the second diffraction grating 27 subsequently enters and is reflected from the reference mirror 28. The reference light 8C reflected from the reference mirror 28 re-enters the second diffraction grating 27. The reference light 8C having re-entered the second diffraction grating 27 is diffracted by and transmits through the second diffraction grating 27. The reference light BC again transmitted through the second diffraction grating 27 further enters the first diffraction grating 26 for the second time. The reference light 8C having entered the first diffraction grating 26 for the second time is diffracted by and transmits through the first diffraction grating 26. The reference light 8C having transmitted the first diffraction grating 26 twice is output from the reference unit 25.

Such reference light 8C having entered the reference unit 25 is provided with the optical path length difference being different for each wavelength similarly to the reference unit 7 according to the first embodiment. Here, a description will be given of the relationship among the first diffraction grating 26, the second diffraction grating 27, and the reference mirror 28 for providing the reference light 8C with the optical path length difference being different for each wavelength. It is to be noted that, in the following description, the first pitch of the first diffraction grating 26 is referred to as p₁, the angle of the reference light 8C entering the first diffraction grating 26 is referred to as θ₁, and the diffraction angle at the first diffraction grating 26 is referred to as η₁; and the second pitch of the second diffraction grating 27 is referred to as p₂, the angle of the reference light 8C entering the second diffraction grating 27 is referred to as θ₂, the diffraction angle at the second diffraction grating 27 is η₁₂, and the diffraction order is n.

The reference mirror 28 is arranged to face the second diffraction grating 27 for causing the reference light 8C having transmitted through the second diffraction grating 27 to reversely progress on the optical path of the reference light 8C (the second grating plane 27a and the reflection plane 28a are arranged in parallel to each other). In this case, unless the reference light 8C enters the reference mirror 28 from the identical direction despite the wavelength being different, the reference light 8C does not reversely progress the optical path of the reference light 8C, and does not enter the second diffraction grating 27 again. Accordingly, the reference light 8C entering the reference mirror 28 must be diffracted by the second diffraction grating 27 in the identical direction. That is, the diffraction angle of the reference light 8C entering the reference mirror 28 must be (rad). It is to be noted that, in the case where the diffraction angle is not 0 (rad), the reference light 8C having transmitted through the second diffraction grating does not enter the reference mirror 28 from the identical direction, because the value of diffraction angle differs for each wavelength. From the foregoing, 0 (rad) is substituted into diffraction angle η₂ in Equation (3), to derive the following Equation (21).

$$sin {θ}_{2} = n \frac{λ}{{p}_{2}} \qquad ( 21 )$$

Further, similarly to the relationship between the first diffraction grating 20 and the second diffraction grating 21 according to the first embodiment, the first diffraction grating 26 and the second diffraction grating must be arranged such that the grating (grooves) direction of the first diffraction grating 26 and that of the second diffraction grating 27 (i.e., the first direction and the second direction) are in parallel to each other and the first grating plane 26a and the second grating plane 27a are in parallel to each other. Accordingly, the relationship of Equation (6) is established. Further, as has been described in the first embodiment, the light must perpendicularly enter the first grating plane 26a. Accordingly, the incident angle η₁ is 0 (rad). From the foregoing, Equation (21) can be expressed by the following Equation (22).

$$sin {η}_{1} = n \frac{λ}{{p}_{1}} = n \frac{λ}{{p}_{2}} \qquad ( 22 )$$

From Equation (22), it can be seen that p₁ and p₂ must be equal to each other. Summarizing the foregoing, the structure conditions that the first diffraction grating 26, the second diffraction grating 27, and the reference mirror 28 must satisfy are the following four conditions.

Firstly, the first diffraction grating 20 and the second diffraction grating 21 are arranged such that the grating (grooves) direction of the first diffraction grating 26 and that of the second diffraction grating 27 (i.e., the first direction and the second direction) are in parallel to each other.

Secondly, the first diffraction grating 26 is arranged such that the reference light 8C perpendicularly enters the first grating plane 26a.

Thirdly, the first diffraction grating 26, the second diffraction grating 27, and the reference mirror 28 are arranged such that the first grating plane 26a, the second grating plane 27a, and the reflection plane 28a are in parallel to one another.

Fourthly, the first pitch p₁ and the second pitch p₂ are equal to each other.

Use of the reference unit 25 including the first diffraction grating 26, the second diffraction grating 27, and the reference mirror 28 satisfying the four structure conditions enables phase shift for each wavelength, by providing the reference light 8C entering the reference unit 25 with a different optical path length for each wavelength. Accordingly, even when the positional relationship of the measurement target plane 3 and the optical system unit 4 is the positional relationship being away from the measurement reference (i.e., the position where the optical path length difference between the measurement light 8B and the reference light 8C is zero), the interference intensity signal can be detected. That is, even when the optical path length difference between the measurement light 8B and the reference light 8C is great, the surface shape measurement apparatus 1 according to the fourth embodiment can detect the interference intensity signal. Therefore, the surface shape can be measured at high speeds.

It is to be noted that the relationship between the first grating plane 26a and the second grating plane 27a in terms of dimension is the same as the relationship between the first grating plane 20a and the second grating plane 21a according to the first embodiment in terms of dimension.

Further, the first diffraction grating 26 is arranged such that the first grating plane 26a faces the second diffraction grating 27. This is to cause the reference light 8C to be diffracted when the reference light 8C exits from the first diffraction grating 26. In this case, since the reference light 8C perpendicularly enters the surface of the first grating plane 26a, it is not affected by the wavelength dispersion of the first diffraction grating 26. Further, the second diffraction grating 27 is arranged such that the second grating plane 27a faces the first diffraction grating 26. This is to cause the reference light 8C to be diffracted when the reference light 8C enters the second diffraction grating 27. In this case, since the diffraction angle of the reference light 8C diffracted from the second grating plane 27a is 0 (rad), it does not affected by the wavelength dispersion when the reference light 8C transmits through the second diffraction grating 27. That is, arrangement of the first diffraction grating 26 and the second diffraction grating 27 such that the first grating plane 26a faces the second grating plane 27a can reduce the effect of the wavelength dispersion when the light transmits through them.

Further, the same diffraction grating can be used for each of the first diffraction grating 26 and the second diffraction grating 27. Since the types of components can be reduced, a reduction in the manufacturing cost of the facility can be achieved. Further, when the measurement target object 2 is changed, the setting of the apparatus can easily be changed. This is because the same change should be made to both the first diffraction grating 26 and the second diffraction grating 27. It is to be noted that the reference unit 25 according to the fourth embodiment can be used for the surface shape measurement apparatus according to the second embodiment.

Here, a description will be given of a variation of the reference unit 25. The variation includes the first diffraction grating 26 and the second diffraction grating 27 as being integrally structured as a diffraction grating 204 being one single member. Specifically, as shown in FIG. 11B, as the diffraction grating 204, a first grating plane 206 and a second grating plane 207 are formed on two planes of a substrate 205 which is a transparent flat substrate, the two planes being in parallel to each other. The first grating plane 206 corresponds to the first grating plane 26a of the first diffraction grating 26. Further, the second grating plane 207 corresponds to the second grating plane 27a of the second diffraction grating 27. The reference mirror 28 is the same also in the variation. That is, the conditions that the first grating plane 206, the second grating plane 207, and the reference mirror 28 should satisfy are identical to the conditions that the first diffraction grating 26, the second diffraction grating 27, and the reference mirror 28 should satisfy as described in the foregoing. It is to be noted that, in FIG. 11B, it is clearly illustrated that the first grating plane 206 and the second grating plane 207 are each a blazed diffraction grating. Further, the first grating plane 206 and the second grating plane 207 both function as the transmission diffraction grating.

According to this variation, measurement can be performed functionally similarly to the manner in which the first diffraction grating 26 and the second diffraction grating 27 are structured by forming the grating planes of the diffraction gratings at two substrates, respectively.

By forming the first grating plane 206 and the second grating plane 207 on the opposite faces of one substrate 205, variations in the distance between the grating planes and in the direction in parallel to the grating plane can be suppressed to the minimum possible extent. Variations in the distance between the grating planes invite a change in the optical path length in each wavelength, which invites an error in measuring the height. Further, variations in the direction parallel to the grating plane invites variations in the interference signal intensity. Specifically, a measurement error in performing the spectrum resolution for each wavelength is invited in calculating the height of the measurement target plane 3. Accordingly, by forming the grating plane on each of the opposite faces of one substrate 205, the factors of such variations can be minimized, and a reduction in the measurement precision can be prevented.

On the other hand, when the diffraction gratings (grating planes) are formed at two separate substrates, respectively, the distance between the grating planes can easily be widened. When the distance between the grating planes is narrow, ±first order diffraction light cannot be split, and the ±first order diffraction light may be mixed with each other. In this case, when the optical path length difference approaches half the wavelength, the intensity of the reference light 8C becomes extremely small, and the interference intensity signal may be detected very little and cannot be measured. That is, forming the diffraction gratings (grating planes) at two separate substrates, the distance enough to split the ±first order diffraction light can easily be adjusted.

Further, as a still another variation, the first diffraction grating 26, the second diffraction grating 27, and the reference mirror 28 may integrally be structured as one single member. Specifically, as shown in FIG. 11C, as one single member 208, a first grating plane 210 and a second grating plane 211 are formed on two planes of a first substrate 209 which is a transparent flat substrate, the two planes being in parallel to each other. Further, a second substrate 212 which is a transparent flat substrate is arranged to share the second grating plane 211. In this case, a reference mirror 213 is arranged at a plane being in parallel to the second grating plane 211 of the second substrate 212. In FIG. 11C, the first grating plane 210 corresponds to the first grating plane 26a of the first diffraction grating 26. Further, the second grating plane 211 corresponds to the second grating plane 27a of the second diffraction grating 27. Further, the reference mirror 213 corresponds to the reference mirror 28.

It is to be noted that, the second diffraction grating 27 and the reference mirror 28 may integrally be structured as one single member, and the first diffraction grating 26 may be structured as a separate member.

### Fifth Embodiment

A surface shape measurement apparatus according to a fifth embodiment corresponds to that according to the fourth embodiment having its reference unit 25 replaced by a reference unit 29 of a different structure. In the following, a description will solely be given of the structure being different from the fourth embodiment.

FIG. 12 shows the reference unit 29 according to the fifth embodiment. The reference unit 29 corresponds to the reference unit 25 according to the fourth embodiment whose transmission first diffraction grating 26 and transmission second diffraction grating 27 are replaced by a reflection first diffraction grating 30 and a reflection second diffraction grating 31, respectively. Further, the second pitch p₂ of the second diffraction grating 31 is equal to the first pitch p₁ of the first diffraction grating 30.

Further, the relationship between the first diffraction grating 30 and the second diffraction grating is the same as the relationship between the first diffraction grating 26 and the second diffraction grating 27 according to the fourth embodiment. Thus, provision of the reflection diffraction gratings can reduce the attenuation of the reference light 8C which occurs when the transmission diffraction grating is used. Accordingly, it becomes possible to detect clearer interfering light, and to improve the precision of the measurement.

However, since it is necessary to secure the wider interval between the diffraction gratings than the case where the transmission diffraction grating is used, it is preferable to use the reference unit 25 according to the fourth embodiment when the chief purpose is miniaturization of the apparatus. It is to be noted that, when it is necessary to increase the light quantity of the reference light 8C, it is preferable to use the reference unit 29 according to the fifth embodiment.

Further, the same diffraction grating can be used for each of the first diffraction grating 30 and the second diffraction grating 31. Since the types of components can be reduced, a reduction in the manufacturing cost of the facility can be achieved. Further, when the measurement target object 2 is changed, the setting of the apparatus can easily be changed. It is to be noted that the reference unit 29 according to the fifth embodiment can be used for the surface shape measurement apparatus according to the second embodiment.

<First Variation>

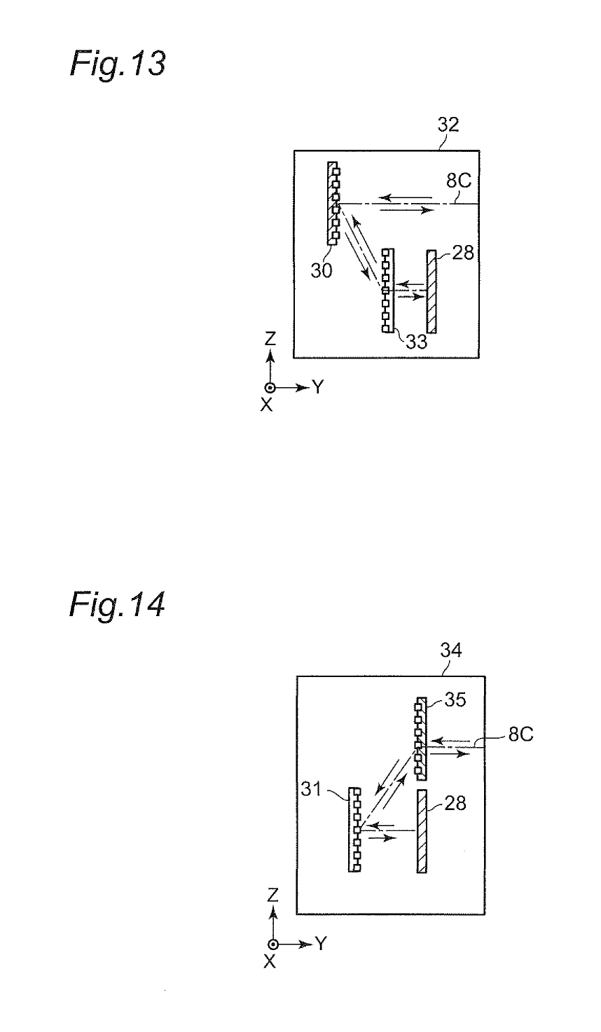

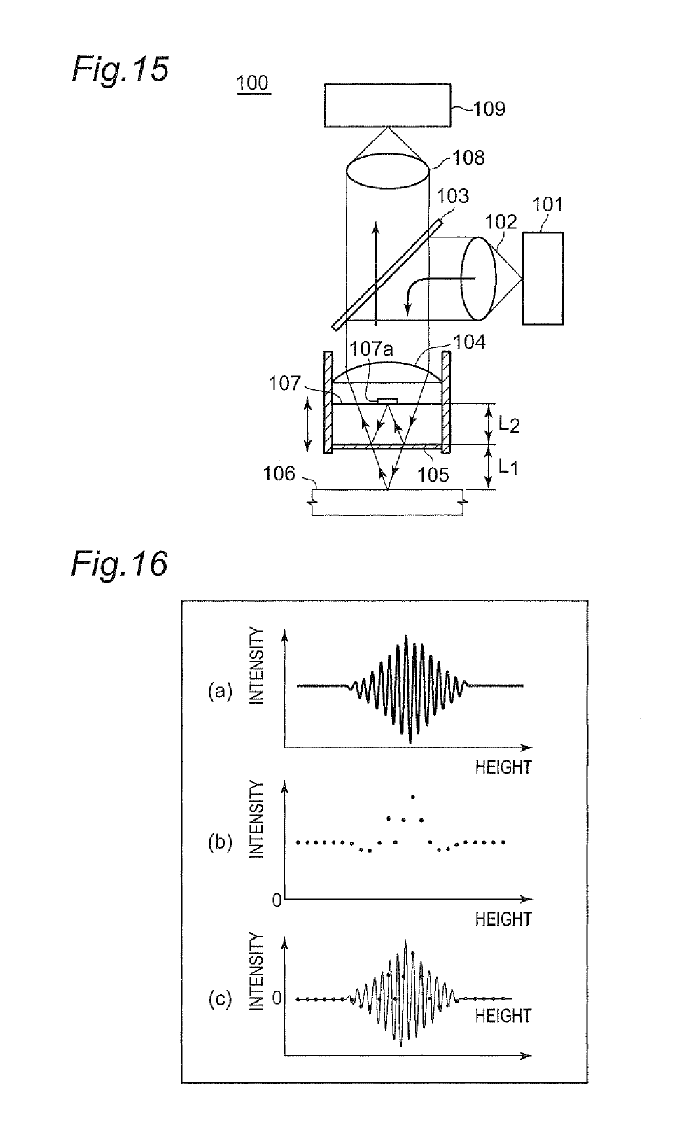

As a first variation of the fifth embodiment, FIG. 13 shows a reference unit 32. The reference unit 32 according to the first variation corresponds to the reference unit 29 according to the fifth embodiment whose reflection second diffraction grating 31 is replaced by a transmission second diffraction grating 33. It is to be noted that the second pitch p₂ of the second diffraction grating 33 is equal to the first pitch p₁ of the first diffraction grating 30. Further, the relationship between the first diffraction grating 30 and the second diffraction grating 33 is the same as the relationship between the first diffraction grating 26 and the second diffraction grating 27 according to the fourth embodiment.

Use of such a reference unit 32 enables phase shift for each wavelength, by providing the reference light 80 entering the reference unit 32 with a different optical path length for each wavelength. Accordingly, even when the positional relationship of the measurement target plane and the optical system unit 4 is the positional relationship being away from the measurement reference (i.e., the position where the optical path length difference between the measurement light 8B and the reference light 8C is zero), the interference intensity signal can be detected. That is, even when the optical path length difference between the measurement light 8B and the reference light 8C is great, the surface shape measurement apparatus according to the first variation can detect the interference intensity signal. Therefore, the surface shape can be measured at high speeds.

### <Second Variation>

As a second variation of the fifth embodiment, FIG. 14 shows a reference unit 34. The reference unit 34 according to the second variation corresponds to the reference unit 29 according to the fifth embodiment whose reflection first diffraction grating 30 is replaced by a transmission first diffraction grating 35. It is to be noted that the second pitch p₂ of the second diffraction grating 31 is equal to the first pitch p₁ of the first diffraction grating 35. Further, the relationship between the first diffraction grating 35 and the second diffraction grating 31 is the same as the relationship between the first diffraction grating 26 and the second diffraction grating 27 according to the fourth embodiment.

Use of such a reference unit 34 enables phase shift for each wavelength, by providing the reference light 8C entering the reference unit 34 with a different optical path length for each wavelength. Accordingly, even when the positional relationship of the measurement target plane and the optical system unit 4 is the positional relationship being away from the measurement reference (i.e., the position where the optical path length difference between the measurement light 8B and the reference light 8C is zero), the interference intensity signal can be detected. That is, even when the optical path length difference between the measurement light 8B and the reference light 8C is great, the surface shape measurement apparatus according to the second variation can detect the interference intensity signal. Therefore, the surface shape can be measured at high speeds.

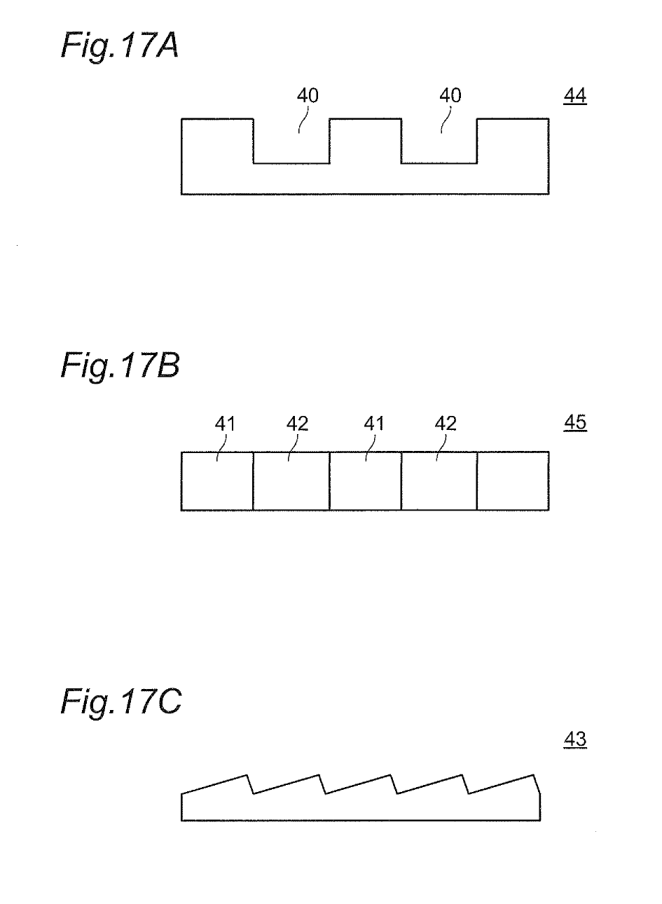

It is to be noted that the present invention is not limited to the foregoing embodiments, and can be practiced in various modes. For example, as to the cross-sectional shape of the grating plane of each diffraction grating, it is not limited to the blazed diffraction grating 43 as shown in FIG. 17C, i.e., it is not limited to a spectroscopic element in which reflection occurs at the surface of each saw-teeth. As other example, as shown in FIG. 17A, a grating plane 44 in which grooves 40 are provided on the substrate, or as shown in FIG. 17B, a grating plane 45 in which portions 41 and 42 differing in refractive index from each other are combined with each other can be used as the diffraction grating.

By properly combining the arbitrary embodiments of the aforementioned various embodiments, the effects possessed by the embodiments can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

The surface shape measurement method and the surface shape measurement apparatus of the present invention make it possible to measure the surface shape of the measurement target plane at high speeds. Therefore, the surface shape measurement method and the surface shape measurement apparatus of the present invention are suitable for the application of measuring the surface shape e.g., a convex and concave shape, of the precision processed product such as a semiconductor wafer or a liquid crystal display-use glass substrate, using interference of the white light at fast speeds.

1. A surface shape measurement method, comprising:
splitting white light that includes different wavelengths into reference light and measurement light;
causing the reference light to enter a first diffraction grating, to thereafter pass through a first optical path to enter a second diffraction grating, and further thereafter causing the reference light to pass through the first optical path from the second diffraction grating to enter the first diffraction grating, while causing the measurement light to enter a measurement target planed to be reflected from the measurement target plane, and combining the reference light and the measurement light to form interfering light;
detecting an interference intensity of the interfering light; and
measuring a surface shape of the measurement target plane based on the interference intensity.

2. The surface shape measurement method according to claim 1, further comprising:
after causing the reference light to pass through the first optical path to enter the second diffraction grating, reflecting the reference light by a mirror, and further thereafter, causing the reference light to pass through the first optical path from the second diffraction grating to enter the first diffraction grating.

3. The surface shape measurement method according to claim 1, wherein;
the reference light has its optical path length changed for each wavelength by the first diffraction grating, and enters the second diffraction grating from the first diffraction grating.

4. A surface shape measurement apparatus, comprising:
a light source that emits white light including different wavelengths;
a splitting unit that splits the white light into reference light and measurement light;
a table on which a measurement target object to which the measurement light is emitted is placed;
a first diffraction grating having a grating in a first direction formed at a first pitch, the reference light perpendicularly entering the first diffraction grating;
a second diffraction grating having a grating in the first direction formed at a pitch half as great as the first pitch, the second diffraction grating being arranged in parallel to the first diffraction grating, and the reference light having exited from the first diffraction grating entering the second diffraction grating;
a combining unit that combines the reference light having exited from the second diffraction grating and thereafter having exited from the first diffraction grating and the measurement light reflected from the measurement target object, to form interfering light;
a detecting unit that detects an interference intensity of the interfering light; and
a measuring unit that measures a surface shape of the measurement target object based on the interference intensity.

5. The surface shape measurement apparatus according to claim 4, wherein;
the splitting unit and the combining unit are implemented by one single member.

6. The surface shape measurement apparatus according to claim 4, wherein;
the first diffraction grating is a transmission diffraction grating, and the second diffraction grating is a reflection diffraction grating.

7. The surface shape measurement apparatus according to claim 4, wherein;
the first diffraction grating and the second diffraction grating are each a reflection diffraction grating.

8. The surface shape measurement apparatus according to claim 4, wherein;
the first diffraction grating and the second diffraction grating are integrally formed by one single member 200.

9. A surface shape measurement apparatus, comprising:
a light source that emits white light including different wavelengths;
a splitting unit that splits the white light into reference light and measurement light;
a table on which a measurement target object to which the measurement light is emitted is placed;
a first diffraction grating having a grating in a first direction formed at a first pitch, the reference light perpendicularly entering the first diffraction grating;
a second diffraction grating having a grating in the first direction formed at the first pitch, the second diffraction grating being arranged in parallel to the first diffraction grating, and the reference light having exited from the first diffraction grating entering the second diffraction grating;
a mirror that reflects the reference light having exited from the second diffraction grating such that the reference light enters the second diffraction grating;
a combining unit that combines the reference light having been reflected from the mirror and thereafter having exited from the second diffraction grating and the first diffraction grating in order and the measurement light reflected from the measurement target object, to form interfering light;
a detecting unit that detects an interference intensity of the interfering light; and
a measuring unit that measures a surface shape of the measurement target object based on the interference intensity.

10. The surface shape measurement apparatus according to claim 9, wherein;
the first diffraction grating and the second diffraction grating are each a reflection diffraction grating.

11. The surface shape measurement apparatus according to claim 9, wherein;
the first diffraction grating and the second diffraction grating are each a transmission diffraction grating.

12. The surface shape measurement apparatus according to claim 9, wherein;
the first diffraction grating is a reflection diffraction grating, and the second diffraction grating is a transmission diffraction grating.

13. The surface shape measurement apparatus according to claim 9, wherein;
the first diffraction grating is a transmission diffraction grating, and the second diffraction grating is a reflection diffraction grating.

14. The surface shape measurement apparatus according to claim 9, wherein;
the first diffraction grating and the second diffraction grating are integrally formed by one single member.

15. The surface shape measurement apparatus according to claim 9, wherein;
the first diffraction grating, the second diffraction grating, and the mirror are integrally formed by one single member.
